(19) United States
(12) Patent Application Publication
(10) Pub. No.: US 2025/0284216 A1
(43) Pub. Date: Sep. 11, 2025

(54) ELECTROPHOTOGRAPHIC PHOTORECEPTOR, PROCESS CARTRIDGE, AND IMAGE FORMING APPARATUS

(71) Applicant: KYOCERA DOCUMENT SOLUTIONS INC., OSAKA (JP)

(72) Inventor: YUICHI YOSHIDA, OSAKA-SHI, OSAKA (JP)

(21) Appl. No.: 19/070,538

(22) Filed: Mar. 5, 2025

(30) Foreign Application Priority Data
Mar. 6, 2024 (JP) 2024-033950

(51) Int. Cl. G03G 5/07; C08G 63/199; C08G 63/672

(52) U.S. Cl. CPC G03G 5/071; C08G 63/199; C08G 63/672; G03G 2215/00957; G03G 2215/00962; G03G 2221/183

(57) ABSTRACT

An electrophotographic photoreceptor includes: a conductive substrate; and a photosensitive layer. The photosensitive layer includes a polyarylate resin, a hole transporting agent, and an antioxidant. The polyarylate resin has a repeating unit represented by the following formula (1) and a repeating unit represented by the following formula (2). The antioxidant is a compound represented by the following formula (AOX1).

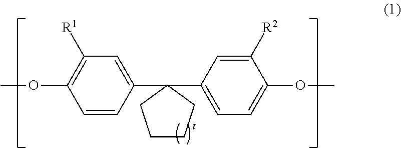

In the formula (1), R¹ and R² each independently represent a hydrogen atom or a methyl group and t represents an integer of 1 or more and 3 or less.

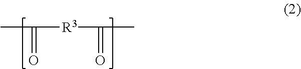

In the formula (2), R³ represents a divalent group represented by the following formula (X1), (X2), or (X3).

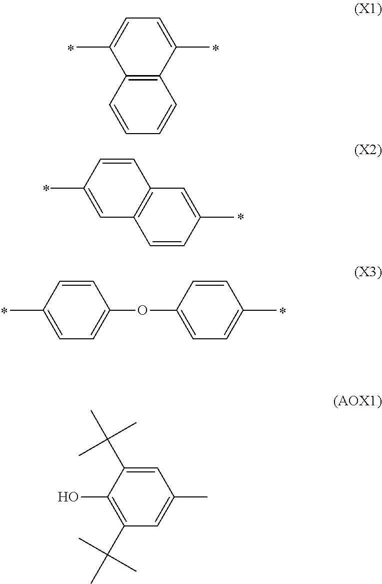

### CROSS-REFERENCE TO RELATED PATENT APPLICATION

This application claims the benefit of Japanese Priority Patent Application JP 2024-033950 filed Mar. 6, 2024, the entire contents of which are incorporated herein by reference.

### FIELD OF THE DISCLOSURE

The present disclosure relates to an electrophotographic photoreceptor, a process cartridge, and an image forming apparatus.

### BACKGROUND OF THE DISCLOSURE

In recent years, there has been an increasing demand for an image forming apparatus that does not include a static elimination device from the viewpoint of space saving and lowering prices. However, in the case where the static elimination process by the static elimination device is not carried out, a transfer bias of opposite polarity to charge polarity is applied to the electrophotographic photoreceptor in a transfer process, and charges of opposite polarity caused by the transfer bias remain in the photosensitive layer of the electrophotographic photoreceptor. As a result, a charging process is carried out again while the potential difference between an exposure region (corresponding to an image region) and a non-exposure region (corresponding to a non-image region) remains on the surface of the electrophotographic photoreceptor from the previous cycle. For this reason, in the case where an image is formed using the image forming apparatus that does not include a static elimination device, an image defect (transfer memory) in which an after image (memory image) caused by the image formed in the previous cycle of the electrophotographic photoreceptor appears occurs in some cases.

Further, the electrophotographic photoreceptor is used as an image carrier in an electrophotographic image forming apparatus (e.g., a printer or a multifunction device). In the case where an image is formed on a recording medium using the image forming apparatus, for example, a charging process, an exposure process, a development process, a transfer process, and a fixing process are carried out. Further, as necessary, a static elimination process and a cleaning process are further carried out. In order to extend the lifetime of the electrophotographic photoreceptor, it is desired to have abrasion resistance and scratch resistance that can withstand repeated use of these processes. Further, in image formation using the electrophotographic method, an image defect called “filming” occurs in some cases due to toner components being attached to the surface of the electrophotographic photoreceptor. For this reason, the electrophotographic photoreceptor is desired to have excellent performance (filming resistance) that allows filming to be prevented from occurring.

As an electrophotographic photoreceptor that allows the residual potential when used repeatedly to be reduced, Japanese Patent No. 5119733 proposes an electrophotographic photoreceptor that includes, in a photosensitive layer, a polyarylate resin as a binder resin, a specific charge transport agent, and a specific additive.

### SUMMARY OF THE DISCLOSURE

An electrophotographic photoreceptor according to the present disclosure includes: a conductive substrate; and a photosensitive layer. The photosensitive layer includes a polyarylate resin, a hole transporting agent, and an antioxidant. The polyarylate resin includes a repeating unit represented by the following formula (1) and a repeating unit represented by the following formula (2). The antioxidant is a compound represented by the following formula (AOX1).

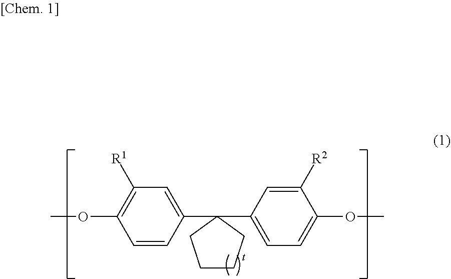

In the formula (1), R¹ and R² each independently represent a hydrogen atom or a methyl group and t represents an integer of 1 or more and 3 or less.

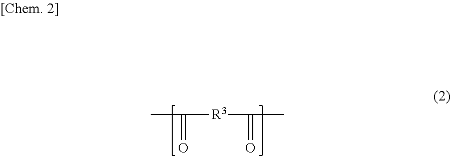

In the formula (2), R³ represents a divalent group represented by the following formula (X1), (X2), or (X3).

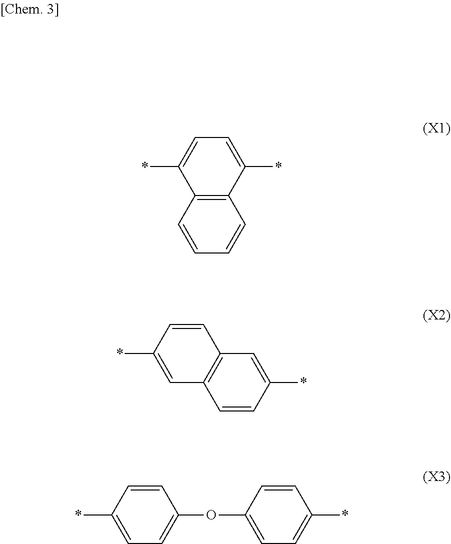 [SMILES: *c1ccc(*)c2ccccc12 ; *c1ccc2cc(*)ccc2c1 ; *c1ccc(Oc2ccc(*)cc2)cc1]

In the formulae (X1), (X2), and (X3), * represents atomic bonding.

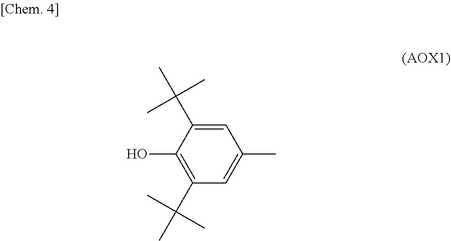 [SMILES: Cc1cc(C(C)(C)C)c(O)c(C(C)(C)C)c1]

A process cartridge according to the present disclosure includes: at least one selected from the group consisting of a charging device, an exposure device, a development device, and a transfer device; and the above-mentioned electrophotographic photoreceptor.

An image forming apparatus according to the present disclosure includes: an image carrier; a charging device that charges a surface of the image carrier; an exposure device that exposes the charged surface of the image carrier to form an electrostatic latent image on the surface of the image carrier; a development device that supplies a toner to the surface of the image carrier to develop the electrostatic latent image as a toner image; and a transfer device that transfers the toner image from the image carrier to a to-be-transferred body. The image carrier is the above-mentioned electrophotographic photoreceptor.

These and other objects, features and advantages of the present disclosure will become more apparent in light of the following detailed description of best mode embodiments thereof, as illustrated in the accompanying drawings.

### BRIEF DESCRIPTION OF THE DRAWINGS

FIG. 1 is a cross-sectional view showing an example of a main part of a stacked-type electrophotographic photoreceptor according to a first embodiment of the present disclosure.

FIG. 2 is a cross-sectional view showing another example of the main part of the stacked-type electrophotographic photoreceptor according to the first embodiment of the present disclosure.

FIG. 3 is a cross-sectional view showing still another example of the main part of the stacked-type electrophotographic photoreceptor according to the first embodiment of the present disclosure.

FIG. 4 is a cross-sectional view showing an example of a main part of a single-layer electrophotographic photoreceptor according to the first embodiment of the present disclosure.

FIG. 5 is a cross-sectional view showing another example of the main part of the single-layer electrophotographic photoreceptor according to the first embodiment of the present disclosure.

FIG. 6 is a cross-sectional view showing an example of an image forming apparatus according to a second embodiment of the present disclosure.

### DETAILED DESCRIPTION OF THE EXEMPLARY EMBODIMENTS

Embodiments of the present disclosure will be described below in detail. However, the present disclosure is not limited to the following embodiments. The present disclosure may be modified in various ways within the essence of the present disclosure, and embodiments obtained by appropriately combining the technical means described in different embodiments are also included in the technical scope of the present disclosure.

Hereinafter, the term “-based” is added after the compound name to collectively refer to the compound and derivatives thereof in some cases. In the case of adding the term “-based” after a compound to refer to a polymer name, it means that the repeating unit of the polymer is derived from the compound or a derivative thereof. Further, a “general formula” and a “chemical formula” are collectively referred to as a “formula”. Further, the phrase “each independently” in the description of the formula means that they may represent the same group or different groups. Further, the components described below may each be used alone or two or more of them may be used in combination. Further, in the present specification, the phrase “at least one of A or B” means “A and/or B”. The phrase “A and/or B” means “A, B, or A and B”.

Further, in the following description, unless otherwise specified, the measured value of a viscosity average molecular weight is a value measured in accordance with Japanese Industrial Standard (JIS) K7252-1:2016.

### First Embodiment: Electrophotographic Photoreceptor

An electrophotographic photoreceptor according to a first embodiment of the present disclosure (hereinafter, referred to simply as a photoreceptor in some cases) will be described below. The photoreceptor according to this embodiment includes a conductive substrate and a photosensitive layer. The photosensitive layer includes at least a polyarylate resin, a hole transporting agent, and an antioxidant. The photoreceptor may be a stacked-type electrophotographic photoreceptor (hereinafter, referred to as a stacked photoreceptor in some cases) or may be a single-layer electrophotographic photoreceptor (hereinafter, referred to as a single-layer photoreceptor in some cases).

### [Stacked Photoreceptor]

A case where a photoreceptor 1 is a stacked photoreceptor will be described below with reference to FIG. 1 to FIG. 3. FIG. 1 to FIG. 3 are each a cross-sectional view showing an example of a main part of the photoreceptor 1 (more specifically, a stacked photoreceptor).

As shown in FIG. 1, the stacked photoreceptor that is an example of the photoreceptor 1 includes, for example, a conductive substrate 2 and a photosensitive layer 3. In the case where the photoreceptor 1 is a stacked photoreceptor, the photosensitive layer 3 includes a charge generating layer 3a and a charge transporting layer 3b. That is, in the stacked photoreceptor, the charge generating layer 3a and the charge transporting layer 3b are provided as the photosensitive layer 3. The charge generating layer 3a includes a charge generating agent. The charge generating layer 3a may further include a base resin, as necessary. The charge generating layer 3a may further include an additive, as necessary.

The charge transporting layer 3b includes at least a binder resin, a hole transporting agent, and an antioxidant. The binder resin includes at least a polyarylate resin described below (hereinafter, referred to as a specific polyarylate resin in some cases). The antioxidant includes at least an antioxidant described below (hereinafter, referred to as a specific antioxidant in some cases). The charge transporting layer 3b may further include an additive such as an electron acceptor compound and/or a leveling agent, as necessary.

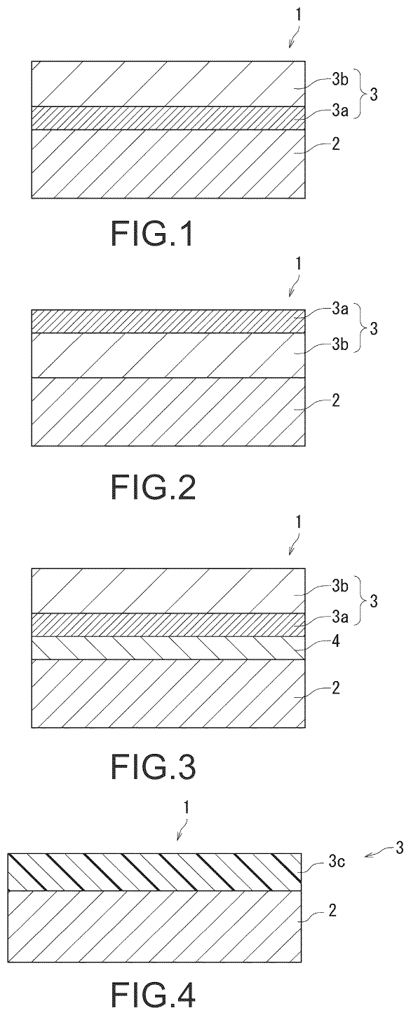

As shown in FIG. 1, in the photoreceptor 1, the charge generating layer 3a may be provided on the conductive substrate 2 and the charge transporting layer 3b may be provided on the charge generating layer 3a. Alternatively, as shown in FIG. 2, in the photoreceptor 1, the charge transporting layer 3b may be provided on the conductive substrate 2 and the charge generating layer 3a may be provided on the charge transporting layer 3b. However, by providing, as a top surface layer, the charge transporting layer 3b including the specific polyarylate resin, the hole transporting agent, and the specific antioxidant, it is possible to obtain the photoreceptor 1 having more excellent abrasion resistance, filming resistance, scratch resistance, and effect of suppressing transfer memory. For this reason, it is favorable that in the photoreceptor 1, the charge transporting layer 3b is provided on the charge generating layer 3a.

Further, as shown in FIG. 3, the photoreceptor 1 may further include an intermediate layer 4 (undercoat layer) in addition to the conductive substrate 2 and the photosensitive layer 3. The intermediate layer 4 is provided between the conductive substrate 2 and the photosensitive layer 3. As shown in FIG. 1 and FIG. 2, in the photoreceptor 1, the photosensitive layer 3 may be provided directly on the conductive substrate 2. Alternatively, as shown in FIG. 3, in the photoreceptor 1, the photosensitive layer 3 may be provided on the conductive substrate 2 via the intermediate layer 4. In the case where the photoreceptor 1 includes the intermediate layer 4, as shown in FIG. 3, the intermediate layer 4 may be provided on the conductive substrate 2, the charge generating layer 3a may be provided on the intermediate layer 4, and the charge transporting layer 3b may be provided on the charge generating layer 3a. Alternatively, the intermediate layer 4 may be provided on the conductive substrate 2, the charge transporting layer 3b may be provided on the intermediate layer 4, and the charge generating layer 3a may be provided on the charge transporting layer 3b.

As shown in FIG. 1 to FIG. 3, the photosensitive layer 3 (e.g., the charge transporting layer 3b or the charge generating layer 3a) may be provided as the top surface layer of the photoreceptor 1. Alternatively, a protective layer (not shown) may be provided as the top surface layer of the photoreceptor 1. However, in general, in the case where the protective layer is formed on the photosensitive layer, charges tend to accumulate at the interface between the photosensitive layer and the protective layer, and the potential difference between the exposure region and the non-exposure region tends to increase. When the potential difference between the exposure region and the non-exposure region increases, transfer memory becomes more likely to occur. For this reason, as shown in FIG. 1 to FIG. 3, it is favorable that the photosensitive layer 3 is provided as the top surface layer of the photoreceptor 1. Further, as described above, by providing, as a top surface layer, the charge transporting layer 3b including the specific polyarylate resin, the hole transporting agent, and the specific antioxidant, it is possible to obtain the photoreceptor 1 having more excellent abrasion resistance, filming resistance, scratch resistance, and effect of suppressing transfer memory.

The electrophotographic photoreceptor disclosed in Japanese Patent No. 5119733 does not take into account abrasion resistance and leaves room for improvement in terms of abrasion resistance. Further, the present inventors have found that the existing electrophotographic photoreceptor has insufficient abrasion resistance, filming resistance, scratch resistance, and suppression of transfer memory. On the other hand, the photoreceptor 1 described above has excellent abrasion resistance, filming resistance, and scratch resistance and is capable of suppressing transfer memory.

The thickness of the charge generating layer 3a is not particularly limited, but is favorably 0.01 μm or more and 5.00 μm or less, more favorably 0.10 μm or more and 3.00 μm or less.

The thickness of the charge transporting layer 3b is not particularly limited, but is favorably 2.00 μm or more and 100.0 μm or less, more favorably 5.00 μm or more and 50.00 μm or less. The case where the photoreceptor 1 is a stacked photoreceptor has been described above with reference to FIG. 1 to FIG. 3.

### [Single-Layer Photoreceptor]

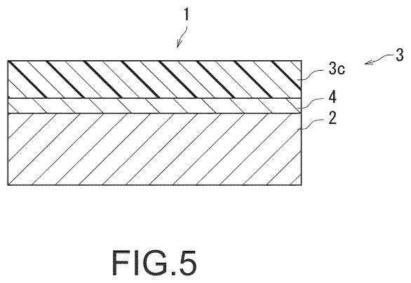

A case where the photoreceptor 1 is a single-layer photoreceptor will be described below with reference to FIG. 4 and FIG. 5. FIG. 4 and FIG. 5 are each a cross-sectional view showing an example of a main part of the photoreceptor 1 (more specifically, a single-layer photoreceptor).

As shown in FIG. 4, the single-layer photoreceptor that is an example of the photoreceptor 1 includes, for example, the conductive substrate 2 and the photosensitive layer 3. The photosensitive layer 3 included in the single-layer photoreceptor is one layer (single layer). Hereinafter, the photosensitive layer 3 included in the single-layer photoreceptor will be referred to as a single-layer photosensitive layer 3c in some cases. The single-layer photosensitive layer 3c includes at least a binder resin, a hole transporting agent, and an antioxidant. The binder resin includes at least the specific polyarylate resin. The antioxidant includes at least the specific antioxidant. The single-layer photosensitive layer 3c may include a charge generating agent and various additives, as necessary.

As shown in FIG. 4, the single-layer photosensitive layer 3c may be provided directly on the conductive substrate 2. Alternatively, as shown in FIG. 5, the single-layer photosensitive layer 3c may be provided on the conductive substrate 2 via the intermediate layer 4.

As shown in FIG. 4 and FIG. 5, the single-layer photosensitive layer 3c may be provided as a top surface layer. Alternatively, a protective layer (not shown) may be provided on the single-layer photosensitive layer 3c as the top surface layer of the photoreceptor 1.

The thickness of the single-layer photosensitive layer 3c is not particularly limited, but is favorably 5.00 μm or more and 100.00 μm or less, more favorably 10.00 μm or more and 50.00 μm or less.

The case where the photoreceptor 1 is a single-layer photoreceptor has been described above with reference to FIG. 4 and FIG. 5. The photoreceptor will be further described below.

### [Conductive Substrate]

The conductive substrate 2 contains aluminum or an aluminum alloy. When the conductive substrate 2 contains aluminum or an aluminum alloy, the transfer of charges from the photosensitive layer 3 to the conductive substrate 2 tends to be improved. Note that the shape of the conductive substrate 2 is appropriately selected in accordance with the structure of an image forming apparatus described below in a second embodiment. Examples of the shape of the conductive substrate 2 include a sheet shape and a drum shape. Further, the thickness of the conductive substrate 2 is appropriately selected in accordance with the shape of the conductive substrate 2.

### [Photosensitive Layer]

As described above, the photosensitive layer 3 includes at least a binder resin, a hole transporting agent, and an antioxidant. The binder resin includes at least the specific polyarylate resin. The antioxidant includes at least the specific antioxidant. Next, the specific polyarylate resin, the hole transporting agent, and the specific antioxidant included in the photosensitive layer 3 will be described. Further, other additives such as a binder resin other than the specific polyarylate resin (hereinafter, referred to as a different binder resin in some cases), an antioxidant other than the specific antioxidant, a charge generating agent, a base resin, an electron acceptor compound, and a leveling agent, which may be included in the photosensitive layer as necessary, will be also described.

### [Specific Polyarylate Resin]

The photosensitive layer 3 includes the specific polyarylate resin as a binder resin. The specific polyarylate resin includes at least one repeating unit derived from bisphenol represented by the following formula (1) and at least one repeating unit derived from dicarboxylic acid represented by the following formula (2).

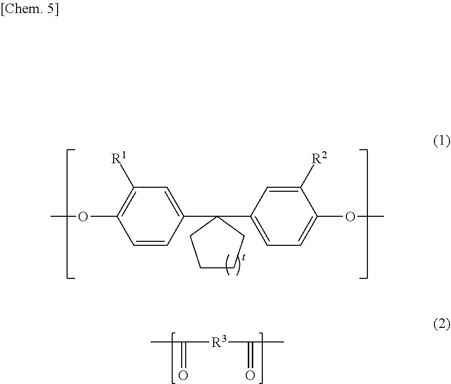

In the formula (1), R¹ and R² each independently represent a hydrogen atom or a methyl group. t represents an integer of 1 or more and 3 or less. In the formula (2), R³ represents a divalent group represented by the following formula (X1), (X2), or (X3).

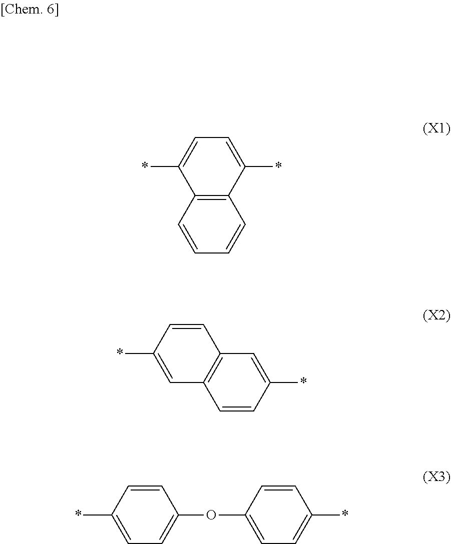 [SMILES: *c1ccc(*)c2ccccc12 ; *c1ccc2cc(*)ccc2c1 ; *c1ccc(Oc2ccc(*)cc2)cc1]

Further, in the formulae (X1), (X2), and (X3), * represents atomic bonding.

Hereinafter, the repeating units represented by the formulae (1) and (2) will be respectively referred to as repeating units (1) and (2) in some cases. Further, hereinafter, the divalent groups represented by the formulae (X1), (X2), and (X3) will be respectively referred to as groups (X1), (X2), and (X3) in some cases.

When the photosensitive layer 3 includes the specific polyarylate resin as a binder resin, it is possible to obtain the photoreceptor 1 having excellent abrasion resistance, filming resistance, scratch resistance, and effect of suppressing transfer memory.

Note that in the formula (1), t favorably represents 2.

Examples of the repeating unit (1) include a repeating unit represented by the following formula (P-1). Hereinafter, the repeating unit represented by the following formula (P-1) will be referred to as a repeating unit (P-1) in some cases. The at least one repeating unit (1) favorably includes the repeating unit (P-1). The repeating unit (1) is favorably the repeating unit (P-1).

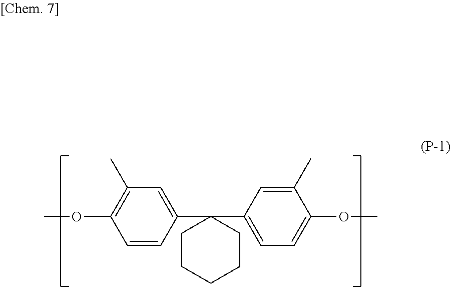

Examples of the repeating unit (2) include repeating units represented by the following formulae (C-1), (C-2), and (C-3). Hereinafter, the repeating units represented by the formulae (C-1), (C-2), and (C-3) will be respectively referred to as repeating units (C-1), (C-2), and (C-3) in some cases. The at least one repeating unit (2) favorably includes at least one repeating unit selected from the group consisting of the repeating units (C-1), (C-2), and (C-3), and favorably includes one or two of them. The repeating unit (2) favorably includes at least one repeating unit selected from the group consisting of the repeating units (C-1), (C-2), and (C-3), and favorably includes one or two of them.

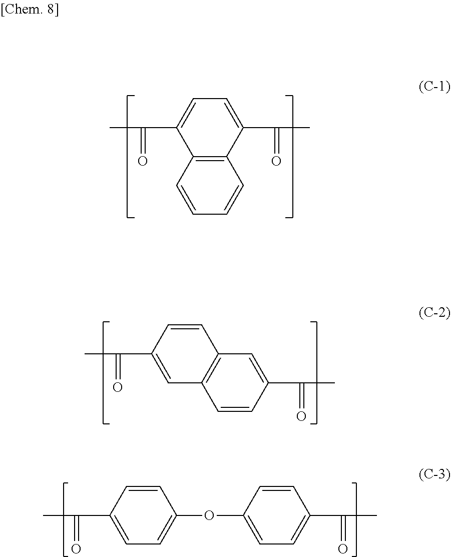

The specific polyarylate resin favorably includes the repeating unit (P-1) and at least one repeating unit selected from the group consisting of the repeating units (C-1), (C-2), and (C-3). Further, the specific polyarylate resin favorably includes the repeating unit (P-1) and one or two repeating units selected from the group consisting of the repeating units (C-1), (C-2), and (C-3).

The specific polyarylate resin may have only the repeating units (1) and (2) as repeating units. For example, the specific polyarylate resin may have only the repeating unit (P-1) and at least one repeating unit selected from the group consisting of the repeating units (C-1), (C-2), and (C-3) as repeating units. Further, the specific polyarylate resin may have, as repeating units, at least one of a repeating unit derived from bisphenol other than the repeating unit (1) or a repeating unit derived from dicarboxylic acid other than the repeating unit (2), in addition to the repeating units (1) and (2).

Suitable examples of the repeating unit derived from bisphenol other than the repeating unit (1) include the repeating unit represented by the formula (P-2), (P-3), (P-4), or (P-5). Among these, the repeating units represented by the formulae (P-4) and (P-5) are more favorable. When the specific polyarylate resin further has, as a repeating unit derived from bisphenol, at least one of the repeating units represented by the formulae (P-2), (P-3), (P-4), and (P-5), in addition to the repeating unit (1), it is possible to obtain the photoreceptor 1 having more excellent abrasion resistance and effect of suppressing transfer memory.

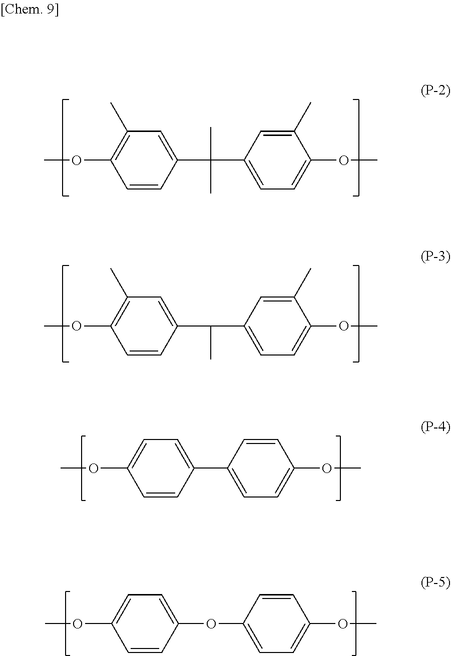

Suitable examples of the repeating unit derived from dicarboxylic acid other than the repeating unit (2) include the repeating unit represented by the formula (C-4). When the specific polyarylate resin further has, as a repeating unit derived from dicarboxylic acid, the repeating unit represented by the formula (C-4), in addition to the repeating unit (2), it is possible to obtain the photoreceptor 1 having more excellent abrasion resistance and effect of suppressing transfer memory.

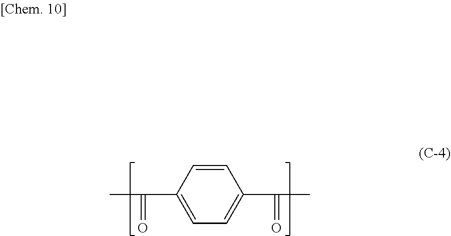

Therefore, it is favorable that the specific polyarylate resin further has at least one of repeating units represented by the following formulae (P-2), (P-3), (P-4), (P-5), and (C-4), and it is more favorable that the specific polyarylate resin further has at least one of the repeating units represented by the formulae (P-4), (P-5), and (C-4). Hereinafter, the repeating units represented by the formulae (P-2), (P-3), (P-4), (P-5), and (C-4) will be respectively referred to as repeating units (P-2), (P-3), (P-4), (P-5), and (C-4) in some cases.

In the specific polyarylate resin, the repeating unit derived from bisphenol and the repeating unit derived from dicarboxylic acid are adjacent and bonded to each other. For this reason, the specific polyarylate resin has at least a molecular chain in which the repeating unit (1) and the repeating unit (2) are adjacent and bonded to each other. Note that the repeating unit (1) may be bonded to the repeating unit (2) or may be bonded to the repeating unit derived from dicarboxylic acid other than the repeating unit (2). The repeating unit (2) may be bonded to the repeating unit (1) or may be bonded to the repeating unit derived from bisphenol other than the repeating unit (1).

The specific polyarylate resin may be, for example, a random copolymer, an alternating copolymer, a periodic copolymer, or a block copolymer.

Further, in the case where the specific polyarylate resin has two or more types of repeating units derived from bisphenol, the arrangement of one type of repeating unit derived from bisphenol and the other type of repeating unit derived from bisphenol is not particularly limited. The one type of repeating unit derived from bisphenol and the other type of repeating unit derived from bisphenol can be arranged randomly, alternately, periodically, or for each block via the repeating unit derived from dicarboxylic acid. Further, in the case where the specific polyarylate resin has two or more types of repeating units derived from dicarboxylic acid, the arrangement of one type of repeating unit derived from dicarboxylic acid and the other type of repeating unit derived from dicarboxylic acid is not particularly limited. The one type of repeating unit derived from dicarboxylic acid and the other type of repeating unit derived from dicarboxylic acid can be arranged randomly, alternately, periodically, or for each block via the repeating unit derived from bisphenol.

Suitable examples of the specific polyarylate resin include polyarylate resins (R-1) to (R-7) in which the specific polyarylate resin has a structure represented by the following formula (Y) and W¹, W², W³, and W⁴ represent the repeating units shown in Table 1 in the formula (Y). Note that in Table 1, (P-1), (P-4), (P-5), (C-1), (C-2), (C-3), and (C-4) respectively represent the repeating units (P-1), (P-4), (P-5), (C-1), (C-2), (C-3), and (C-4).

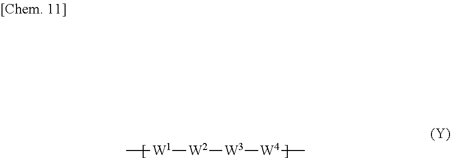

TABLE 1

| Polyarylate resin | W¹ | W² | W³ | W⁴ |
|---|---|---|---|---|
| R-1 | P-1 | C-2 | P-1 | C-3 |
| R-2 | P-1 | C-1 | P-4 | C-2 |
| R-3 | P-1 | C-2 | P-4 | C-3 |
| R-4 | P-1 | C-3 | P-4 | C-3 |
| R-5 | P-1 | C-1 | P-5 | C-2 |
| R-6 | P-1 | C-1 | P-5 | C-4 |
| R-7 | P-1 | C-3 | P-5 | C-4 |

In the polyarylate resin (R-1), the repeating unit (1) is the repeating unit (P-1) and the repeating unit (2) is the repeating units (C-2) and (C-3).

In the polyarylate resin (R-2), the repeating unit (1) is the repeating unit (P-1) and the repeating unit (2) is the repeating units (C-1) and (C-2). The polyarylate resin (R-2) further has the repeating unit (P-4) as the repeating unit derived from bisphenol.

In the polyarylate resin (R-3), the repeating unit (1) is the repeating unit (P-1) and the repeating unit (2) is the repeating units (C-2) and (C-3). The polyarylate resin (R-3) further has the repeating unit (P-4) as the repeating unit derived from bisphenol.

In the polyarylate resin (R-4), the repeating unit (1) is the repeating unit (P-1) and the repeating unit (2) is the repeating unit (C-3). The polyarylate resin (R-4) further has the repeating unit (P-4) as the repeating unit derived from bisphenol.

In the polyarylate resin (R-5), the repeating unit (1) is the repeating unit (P-1) and the repeating unit (2) is the repeating units (C-1) and (C-2). The polyarylate resin (R-5) further has the repeating unit (P-5) as the repeating unit derived from bisphenol.

In the polyarylate resin (R-6), the repeating unit (1) is the repeating unit (P-1) and the repeating unit (2) is the repeating unit (C-1). The polyarylate resin (R-6) further has the repeating unit (P-5) as the repeating unit derived from bisphenol and the repeating unit (C-4) as the repeating unit derived from dicarboxylic acid.

In the polyarylate resin (R-7), the repeating unit (1) is the repeating unit (P-1) and the repeating unit (2) is the repeating unit (C-3). The polyarylate resin (R-7) further has the repeating unit (P-5) as the repeating unit derived from bisphenol and the repeating unit (C-4) as the repeating unit derived from dicarboxylic acid.

As described above, the specific polyarylate resin only needs to have the repeating units (1) and (2) as repeating units. However, the specific polyarylate resin may further have, as repeating units, the repeating unit derived from bisphenol other than the repeating unit (1) and/or the repeating unit derived from bisphenol other than the repeating unit (2), as described above. When the specific polyarylate resin further has suitably at least one of the repeating units (P-2), (P-3), (P-4), (P-5), and (C-4), more suitably at least one of the repeating units (P-4), (P-5), and (C-4), in addition to the repeating units (1) and (2), it is possible to obtain the photoreceptor 1 having more excellent abrasion resistance and effect of suppressing transfer memory.

The content ratio of the repeating unit (1) with respect to the total number of repeating units derived from bisphenol in the specific polyarylate resin is favorably 50% or more, more favorably 70% or more, and still more favorably 90% or more. The content ratio of the repeating unit (1) with respect to the total number of repeating units derived from bisphenol in the specific polyarylate resin can be adjusted by changing the amount (unit: mole) of bisphenol added to form the repeating unit (1) with respect to the total amount (unit: mole) of bisphenol added in the production of the specific polyarylate resin.

The content ratio of the repeating unit (2) with respect to the total number of repeating units derived from dicarboxylic acid in the specific polyarylate resin is favorably 60% or more, more favorably 70% or more, and still more favorably 90% or more. The content ratio of the repeating unit (2) with respect to the total number of repeating units derived from dicarboxylic acid in the specific polyarylate resin can be adjusted by changing the amount (unit: mole) of dicarboxylic acid added to form the repeating unit (2) with respect to the total amount (unit: mole) of dicarboxylic acid added in the production of the specific polyarylate resin.

Further, the specific polyarylate resin may have a terminal group. Examples of the terminal group of the specific polyarylate resin include a terminal group represented by the following formula (T-1). As the terminal group represented by the formula (T-1), a terminal group represented by the following formula (T-DMP) (hereinafter, referred to as a terminal group (T-DMP) in some cases) is favorable.

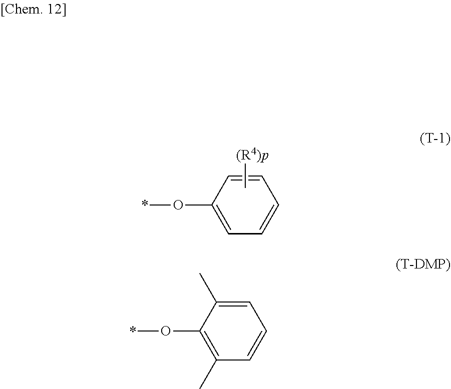

In the formula (T-1), R⁴ represents an alkyl group having 1 or more and 6 or less carbon atoms or a halogen atom and p represents an integer of 0 or more and 5 or less. R⁴ represents favorably an alkyl group having 1 or more and 6 or less carbon atoms, more favorably an alkyl group having 1 or more and 3 or less carbon atoms, and still more favorably a methyl group. p represents favorably an integer of 1 or more and 3 or less, more favorably 2.

In the formulae (T-1) and (T-DMP), * represents atomic bonding. The atomic bonding represented by * in the formulae (T-1) and (T-DMP) is bonded to the repeating unit located at the end of the specific polyarylate resin.

The viscosity average molecular weight of the specific polyarylate resin is favorably 10,000 or more, more favorably 20,000 or more, and particularly favorably 30,000 or more. When the viscosity average molecular weight of the specific polyarylate resin is 10,000 or more, the abrasion resistance of the photoreceptor is improved. Meanwhile, the viscosity average molecular weight of the specific polyarylate resin is favorably 80,000 or less, more favorably 70,000 or less. When the viscosity average molecular weight of the specific polyarylate resin is 80,000 or less, the specific polyarylate resin is easily dissolved in a solvent for forming a charge transporting layer and a solvent for forming a single-layer photosensitive layer, which allows a charge transporting layer and a single-layer photosensitive layer to be formed easier.

Next, a method of producing the specific polyarylate resin will be described. Examples of the method of producing the specific polyarylate resin include a method of polycondensing bisphenol(bisphenol monomer) for forming the repeating unit derived from bisphenol and dicarboxylic acid (dicarboxylic acid monomer) for forming the repeating unit derived from dicarboxylic acid. As bisphenol for forming the repeating unit derived from bisphenol, bisphenol including bisphenol for forming the repeating unit (1) is used. As dicarboxylic acid for forming the repeating unit derived from dicarboxylic acid, dicarboxylic acid including dicarboxylic acid for forming the repeating unit (2) is used.

Examples of bisphenol for forming the repeating unit (1) include a compound represented by the following formula (1-1). Examples of bisphenol for forming the repeating unit derived from bisphenol other than the repeating unit (1) include compounds represented by the following formulae (1-2), (1-3), (1-4), and (1-5). Hereinafter, the compounds represented by the formulae (1-1), (1-2), (1-3), (1-4), and (1-5) will be respectively referred to as compounds (1-1), (1-2), (1-3), (1-4), and (1-5) in some cases.

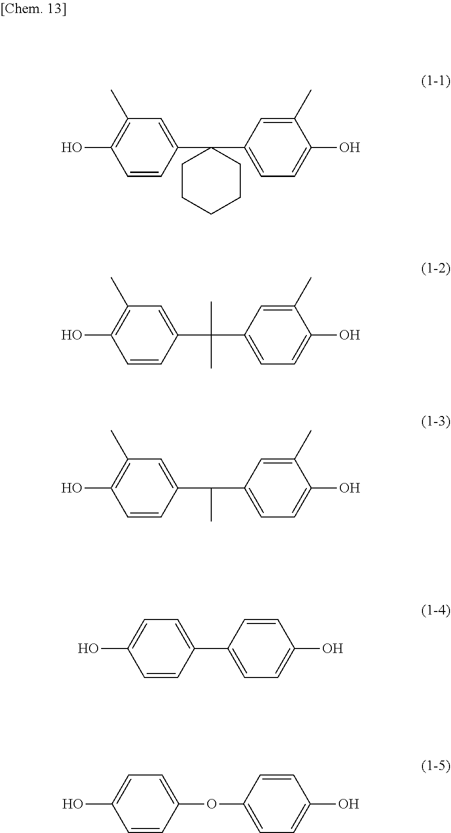

Further, examples of dicarboxylic acid for forming the repeating unit (2) include compounds represented by the following formulae (2-1), (2-2), and (2-3). Examples of dicarboxylic acid for forming the repeating unit derived from dicarboxylic acid other than the repeating unit (2) include a compound represented by the following formula (2-4). Hereinafter, the compounds represented by the formulae (2-1), (2-2), (2-3), and (2-4) will be respectively referred to as compounds (2-1), (2-2), (2-3), and (2-4) in some cases.

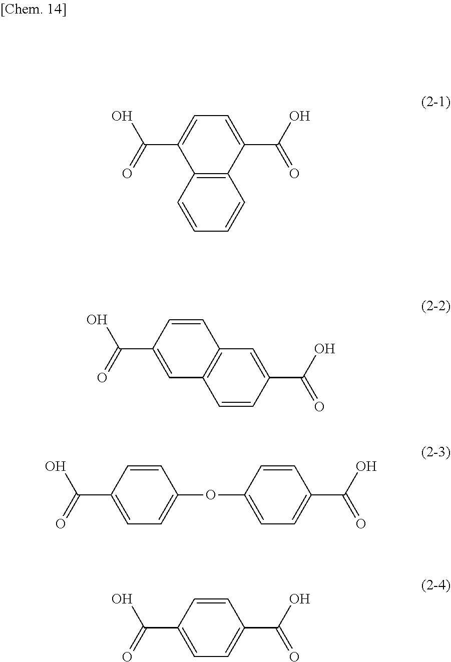

In the polycondensation of bisphenol and dicarboxylic acid, a terminal stopper may be added. Examples of the terminal stopper include 2,6-dimethylphenol. By using 2,6-dimethylphenol as a terminal stopper, the terminal group (T-DMP) can be formed.

In the polycondensation of bisphenol and dicarboxylic acid, one or both of a base and a catalyst may be added. Examples of the base include sodium hydroxide. Examples of the catalyst include benzyltributylammonium chloride, ammonium chloride, ammonium bromide, a quaternary ammonium salt, triethylamine, and trimethylamine.

The photosensitive layer 3 favorably includes only the specific polyarylate resin as a binder resin. However, the photosensitive layer 3 may further include a different binder resin other than the specific polyarylate resin, in addition to the specific polyarylate resin. The content ratio of the specific polyarylate resin in the binder resin is favorably 80 mass % or more, more favorably 90 mass % or more, and still more favorably 100 mass %.

Examples of the different binder resin include a thermoplastic resin (more specifically, a polyarylate resin other than the specific polyarylate resin, a polycarbonate resin, a styrene resin, a styrene-butadiene copolymer, a styrene-acrylonitrile copolymer, a styrene-maleic acid copolymer, a styrene-acrylic acid copolymer, an acrylic copolymer, a polyethylene resin, an ethylene-vinyl acetate copolymer, a chlorinated polyethylene resin, a polyvinyl chloride resin, a polypropylene resin, an ionomer, a vinyl chloride-vinyl acetate copolymer, a polyester resin, an alkyd resin, a polyamide resin, polyurethane resin, a polysulfone resin, a diallylphthalate resin, a ketone resin, a polyvinylbutyral resin, a polyvinylacetal resin, and a polyether resin), a thermosetting resin (more specifically, a silicone resin, an epoxy resin, a phenolic resin, a urea resin, a melamine resin, and a cross-linkable thermosetting resin other than these), and a photocurable resin (more specifically, an epoxy-acrylic acid resin and a urethane-acrylic acid copolymer).

### [Hole Transporting Agent]

Examples of the hole transporting agent include a triphenylamine derivative, a diamine derivative (e.g., an N,N,N′,N′-tetraphenylbenzidine derivative, an N,N,N′,N′-tetraphenylphenylenediamine derivative, an N,N,N′,N′-tetraphenylnaphthylenediamine derivative, an N,N,N′,N′-tetraphenylphenanthrylenediamine derivative, and a di(aminophenylethenyl)benzene derivative)), an oxadiazole compound (e.g., 2,5-di(4-methylaminophenyl)-1,3,4-oxadiazole), a styryl compound (e.g., 9-(4-diethylaminostyryl)anthracene), a carbazole compound (e.g., polyvinylcarbazole), an organic polysilane compound, a pyrazoline compound (e.g., 1-phenyl-3-(p-dimethylaminophenyl)pyrazoline), a hydrazone compound, an indole compound, an oxazole compound, an isooxazole compound, a thiazole compound, a thiadiazole compound, an imidazole compound, a pyrazole compound, and a triazole compound.

As the hole transporting agent, a hole transporting agent having a triphenylamine structure is suitably used. Suitable examples of the hole transporting agent include a compound represented by the following formula (HTM).

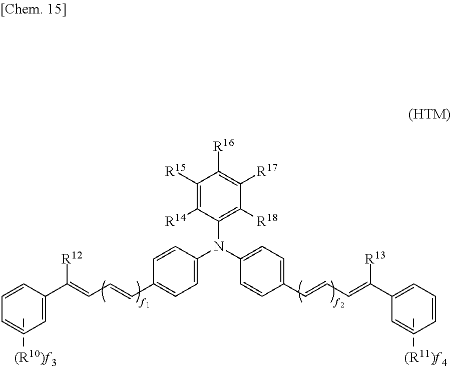

In the formula (HTM), R¹⁰ and R¹¹ each independently represent an alkyl group having 1 or more and 6 or less carbon atoms or an alkoxy group having 1 or more and 6 or less carbon atoms. R¹², R¹³, R¹⁴, R¹⁵, R¹⁶, R¹⁷, and R¹⁸ each independently represent a hydrogen atom, an alkyl group having 1 or more and 6 or less carbon atoms, or an alkoxy group having 1 or more and 6 or less carbon atoms. f₁ and f₂ each independently represent an integer of 0 or more and 2 or less. f₃ and f₄ each independently represent an integer of 0 or more and 5 or less.

As the alkyl group having 1 or more and 6 or less carbon atoms represented by R¹⁰ to R¹⁸, an alkyl group having 1 or more and 4 or less carbon atoms is favorable. As the alkoxy group having 1 or more and 6 or less carbon atoms represented by R¹⁰ to R¹⁸, an alkoxy group having 1 or more and 3 or less carbon atoms is favorable and an ethoxy group is more favorable. R¹² to R¹⁸ favorably each independently a hydrogen atom or an alkoxy group having 1 or more and 6 or less carbon atoms. When f₃ represents an integer of 2 or more and 5 or less, a plurality of R¹⁰ may represent the same group or different groups. When f₄ represents an integer of 2 or more and 5 or less, a plurality of R¹¹ may represent the same group or different groups. f₁ and f₂ favorably represent 1. f₃ and f₄ each independently represent favorably an integer of 0 or more and 2 or less, more favorably 0.

Hereinafter, the compound represented by the formula (HTM) will be referred to as a compound (HTM) in some cases. When the photosensitive layer 3 includes the compound (HTM) as a hole transporting agent as well as the specific polyarylate resin and the specific antioxidant, it is possible to obtain the photoreceptor 1 having more excellent abrasion resistance, filming resistance, scratch resistance, and effect of suppressing transfer memory.

Examples of the compound (HTM) include a compound represented by the following formula (HTM1). Hereinafter, the compound represented by the formula (HTM1) will be referred to as a compound (HTM1) in some cases. When the photosensitive layer 3 includes the compound (HTM1) as a hole transporting agent as well as the specific polyarylate resin and the specific antioxidant, it is possible to obtain the photoreceptor 1 having more excellent abrasion resistance, filming resistance, scratch resistance, and effect of suppressing transfer memory.

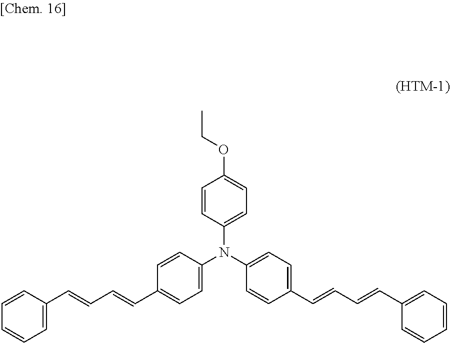 [SMILES: CCOc1ccc(N(c2ccc(/C=C/C=C/c3ccccc3)cc2)c2ccc(/C=C/C=C/c3ccccc3)cc2)cc1]

The content of the hole transporting agent is favorably 10.00 parts by mass or more and 200.00 parts by mass or less, more favorably 40.00 parts by mass or more and 80.00 parts by mass or less, with respect to 100.00 parts by mass of the specific polyarylate resin.

### [Specific Antioxidant]

The photosensitive layer 3 includes the specific antioxidant as an antioxidant. The specific antioxidant is a compound represented by the following formula (AOX1). Hereinafter, the compound represented by the formula (AOX1) will be referred to as a compound (AOX1) in some cases.

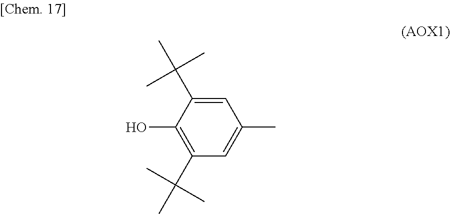 [SMILES: Cc1cc(C(C)(C)C)c(O)c(C(C)(C)C)c1]

When the photosensitive layer 3 include the specific antioxidant as an antioxidant, it is possible to obtain the photoreceptor 1 having excellent abrasion resistance.

The content of the specific antioxidant is favorably 1.00 part by mass or more and 10.00 parts by mass or less, more favorably 3.00 parts by mass or more and 9.00 parts by mass or less, with respect to 100.00 parts by mass of the specific polyarylate resin.

The photosensitive layer 3 favorably includes only the specific antioxidant as an antioxidant. However, the photosensitive layer 3 may further include an antioxidant other than the specific antioxidant, in addition to the specific antioxidant. The content ratio of the specific antioxidant with respect to the mass of the antioxidant is favorably 80 mass % or more, more favorably 90 mass % or more, and still more favorably 100 mass %.

Examples of the antioxidant other than the specific antioxidant include hindered phenol, a hindered amine, a paraphenylenediamine, an aryl alkane, hydroquinone, spirochromane, spiroindanone, or their derivatives, organic sulfur compounds, or organic phosphorus compounds.

### [Charge Generating Agent]

Examples of the charge generating agent include a phthalocyanine pigment, a perylene pigment, a bisazo pigment, a trisazo pigment, a dithioketopyrrolopyrrole pigment, a metal-free naphthalocyanine pigment, a metal naphthalocyanine pigment, a squaraine pigment, an indigo pigment, an azulenium pigment, a cyanine pigment, a powder of an inorganic photoconductive material (e.g., selenium, selenium-tellurium, selenium-arsenic, cadmium sulfide, and amorphous silicon), a pyrylium pigment, an anthanthron pigment, a triphenylmethane pigment, a threne pigment, a toluidine pigment, a pyrazoline pigment, and a quinacridone pigment. The photosensitive layer 3 may include only one type of charge generating agent or may include two or more types of charge generating agents.

The phthalocyanine pigment is a pigment having a phthalocyanine structure. Examples of the phthalocyanine pigment include metal phthalocyanine and metal-free phthalocyanine. Examples of the metal phthalocyanine include titanyl phthalocyanine, hydroxygallium phthalocyanine, and chlorogallium phthalocyanine.

The phthalocyanine pigment may be crystalline or amorphous. Examples of the crystal of the metal-free phthalocyanine include an X-type crystal of the metal-free phthalocyanine (hereinafter, referred to as an X-type metal-free phthalocyanine in some cases). Examples of the crystal of the titanyl phthalocyanine include a-type, p-type, and Y-type crystals of the titanyl phthalocyanine (hereinafter, respectively referred to as a-type, p-type, and Y-type titanyl phthalocyanines in some cases).

For example, for a digital optical image forming apparatus (e.g., a laser beam printer or a facsimile machine using a light source such as semiconductor laser light), it is favorable to use a photoreceptor having sensitivity in a wavelength region of 700 nm or more. As a charge generating agent, a phthalocyanine pigment is favorable, titanyl phthalocyanine is more favorable, and the Y-type titanyl phthalocyanine is still more favorable, because they provide a high quantum yield in the wavelength region of 700 nm or more. Titanyl phthalocyanine is represented by the following formula (CG1).

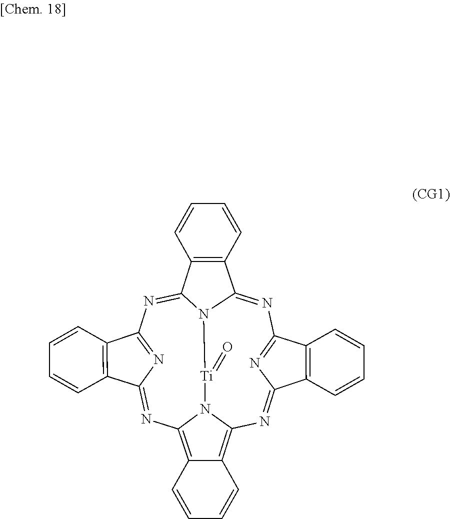

The Y-type titanyl phthalocyanine is a crystal of titanyl phthalocyanine having the main peak at, for example, 27.2° of the Bragg angle 2θ±0.2° in a CuKα characteristic X-ray diffraction spectrum. The main peak in the CuKα characteristic X-ray diffraction spectrum is a peak having the first or second highest intensity in the range of the Bragg angle (2θ±0.2°) of 3° or more and 400 or less. The Y-type titanyl phthalocyanine has a peak at 9.6° of the Bragg angle 2θ±0.2° and does not have a peak at 26.2° C. in the CuKα characteristic X-ray diffraction spectrum.

The CuKα characteristic X-ray diffraction spectrum is measured by, for example, the following method. First, a sample holder of an X-ray diffractometer (e.g., “RINT (registered trademark) 1100” manufactured by Rigaku Holdings Corporation and its Global Subsidiaries) is filled with a sample (titanyl phthalocyanine), and the X-ray diffraction spectrum is measured under the conditions of an X-ray tube Cu, a tube voltage of 40 kV, a tube current of 30 mA, and the wavelength of CuKα characteristic X-rays of 1.542 Å. The measurement range (2θ) is, for example, 3° or more and 400 or less (start angle of 3°, stop angle of 40°), and the scanning speed is, for example, 10°/min. The main peak is determined from the obtained X-ray diffraction spectrum, and the Bragg angle of the main peak is read.

In the case where the photoreceptor is a stacked photoreceptor, the content of the charge generating agent is favorably 10.00 parts by mass or more and 300.00 parts by mass or less, more favorably 100.00 parts by mass or more and 200.00 parts by mass or less, with respect to 100.00 parts by mass of the base resin. In the case where the photoreceptor is a single-layer photoreceptor, the content of the charge generating agent is favorably 0.10 parts by mass or more and 50.00 parts by mass or less with respect to 100.00 parts by mass of the binder resin.

### [Base Resin]

The charge generating layer 3a may include a base resin. Examples of the base resin are the same as the examples of the different binder resin included in the charge transporting layer 3b or the single-layer photosensitive layer 3c. However, in order to suitably form the charge generating layer 3a and the charge transporting layer 3b, it is favorable to select, as a base resin, a resin different from the resin used as a binder resin. As the base resin, for example, a polyvinylacetal resin is used.

### [Electron Acceptor Compound]

In the case where the photoreceptor is a stacked photoreceptor, the charge transporting layer 3b favorably includes an electron acceptor compound. Examples of the electron acceptor compound include a quinone compound, a diimide compound, a hydrazone compound, a malononitrile compound, a thiopyran compound, a trinitrothioxanthone compound, a 3,4,5,7-tetranitro-9-fluorenone compound, a dinitroanthracene compound, a dinitroacridine compound, tetracyanoethylene, 2,4,8-trinitrothioxanthone, dinitrobenzene, dinitroacridine, succinic anhydride, maleic anhydride, and dibromomaleic anhydride. Examples of the quinone compound include a diphenoquinone compound, an azoquinone compound, an anthraquinone compound, a naphthoquinone compound, a nitroanthraquinone compound, and a dinitroanthraquinone compound.

Suitable examples of the electron acceptor compound include a compound represented by the following formula (EA).

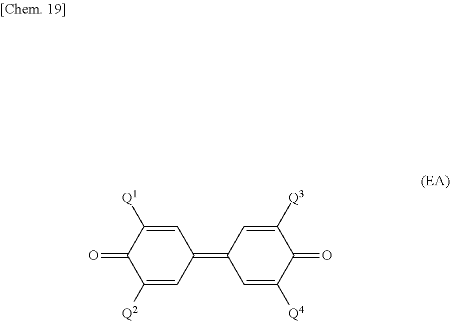

In the formula (EA), Q¹, Q², Q³, and Q⁴ each independently represent an alkyl group having 1 or more and 6 or less carbon atoms, an alkoxy group having 1 or more and 6 or less carbon atoms, a cycloalkyl group having 5 or more and 7 or less carbon atoms, or an aryl group having 6 or more and 14 or less carbon atoms.

As the alkyl group having 1 or more and 6 or less carbon atoms represented by Q¹, Q², Q³, and Q⁴ in the formula (EA), a tert-butyl group is favorable.

As the alkoxy group having 1 or more and 6 or less carbon atoms represented by Q¹, Q², Q³, and Q⁴ in the formula (EA), an alkoxy group having 1 or more and 3 or less carbon atoms is favorable. As the cycloalkyl group having 5 or more and 7 or less carbon atoms represented by Q¹, Q², Q³, and Q⁴ in the formula (EA), a cyclohexyl group is favorable. As the aryl group having 6 or more and 14 or less carbon atoms represented by Q¹, Q², Q³, and Q⁴ in the formula (EA), an aryl group having 6 or more and 10 or less carbon atoms is favorable.

In the formula (EA), Q¹, Q², Q³, and Q⁴ each independently represent favorably an alkyl group having 1 or more and 6 or less carbon atoms, more favorably a tert-butyl group.

Hereinafter, the compound represented by the formula (EA) will be referred to as a compound (EA) in some cases. Suitable examples of the compound (EA) include a compound represented by the following formula (EA1). Hereinafter, the compound represented by the formula (EA1) will be referred to as a compound (EA1) in some cases.

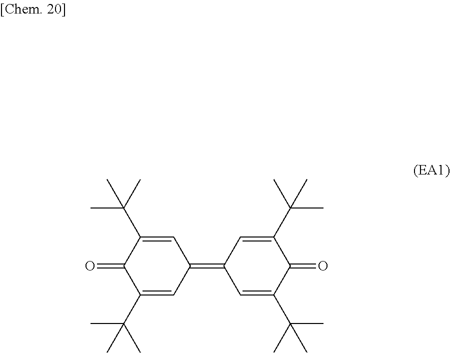 [SMILES: CC(C)(C)C1=CC(=C2C=C(C(C)(C)C)C(=O)C(C(C)(C)C)=C2)C=C(C(C)(C)C)C1=O]

The content of the electron acceptor compound is favorably 0.10 parts by mass or more and 10.00 parts by mass or less, more favorably 1.00 part by mass or more and 5.00 parts by mass or less, with respect to 100.00 parts by mass of the specific polyarylate resin.

### [Additive]

Examples of the additive include a deterioration inhibitor (e.g., an antioxidant, a radical scavenger, a singlet quencher, or an ultraviolet absorber), a softener, a surface modifier, a bulking agent, a thickener, a dispersion stabilizer, a wax, a donor, a surfactant, a plasticizer, a sensitizer, and a leveling agent. Examples of the leveling agent include dimethylsilicone oil.

### [Intermediate Layer]

In the photoreceptor 1, the intermediate layer 4 (undercoat layer) is located, for example, between the conductive substrate 2 and the photosensitive layer 3. The intermediate layer 4 includes, for example, an inorganic particle and a resin used for the intermediate layer 4 (intermediate layer resin). It is conceivable that the presence of the intermediate layer 4 suppresses the increase in resistance by smoothing the flow of current generated when the photoreceptor 1 is exposed, while maintaining the insulation state that allows the occurrence of leakage to be suppressed.

Examples of the inorganic particle include a particle of a metal (e.g., aluminum, iron, or copper) or a metal oxide (e.g., titanium oxide, alumina, zirconium oxide, tin oxide, or zinc oxide) and a particle of a non-metal oxide (e.g., silica). These inorganic particles may be used alone or two or more of them may be used in combination.

The intermediate layer resin is not particularly limited as long as it can be used as a resin for forming the intermediate layer 4.

The intermediate layer 4 may include various additives as long as the electrophotographic properties of the photoreceptor 1 are not adversely affected. Examples of the additives are the same as the examples of the additives in the photosensitive layer 3.

The thickness of the intermediate layer 4 is not particularly limited, but is favorably 0.10 μm or more and 5.00 μm or less.

The photoreceptor 1 according to the first embodiment has been described above with reference to FIG. 1 to FIG. 5. In accordance with the first embodiment, it is possible to provide the photoreceptor 1 having excellent abrasion resistance, filming resistance, scratch resistance, and effect of suppressing transfer memory.

### Second Embodiment: Image Forming Apparatus

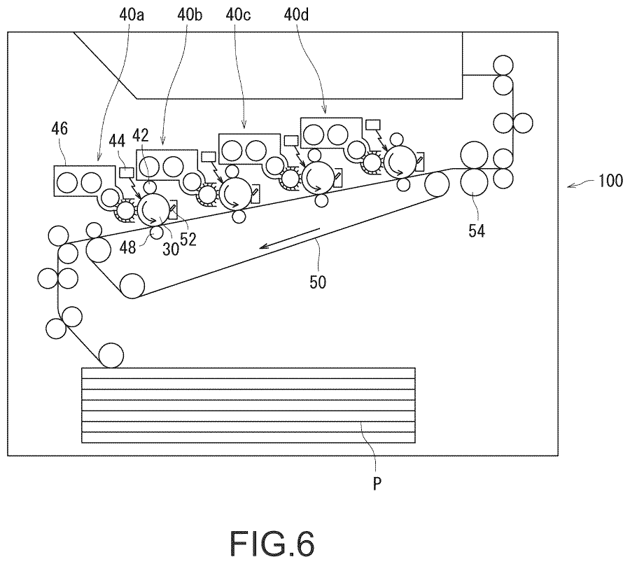

An image forming apparatus according to a second embodiment of the present disclosure will be described below. A tandem type image forming apparatus will be described below as an example with reference to FIG. 6. FIG. 6 is a cross-sectional view showing an example of the image forming apparatus.

An image forming apparatus 100 shown in FIG. 6 includes image formation units 40a, 40b, 40c, and 40d, a transfer belt 50, and a fixing device 54. The image formation units 40a, 40b, 40c, and 40d form toner images of different colors on the basis of an electrostatic latent image.

In the image forming apparatus 100, by the image formation units 40a to 40d, toner images of a plurality of colors (e.g., four colors of black, cyan, magenta, and yellow) are superimposed in order on a recording medium P on the transfer belt 50. Hereinafter, in the case where there is no need to distinguish between these image formation units 40a to 40d, each of the image formation units 40a to 40d will be referred to simply as an image formation unit 40.

The image formation unit 40 includes an image carrier 30, a charging device 42, an exposure device 44, a development device 46, a transfer device 48, and a cleaning blade 52 that cleans the surface of the image carrier 30. The image carrier 30 corresponds to the photoreceptor 1 according to the first embodiment.

As described above, the photoreceptor 1 according to the first embodiment has excellent abrasion resistance, filming resistance, and scratch resistance and is capable of suppressing the occurrence of transfer memory. Therefore, the image forming apparatus 100 according to this embodiment includes, as the image carrier 30, the photoreceptor 1 according to the first embodiment, which allows the abrasion resistance, filming resistance, and scratch resistance of the image carrier 30 to be improved and the transfer memory to be suppressed.

The image carrier 30 is provided at the center of the image formation unit 40. The image carrier 30 is provided to be rotatable in the direction indicated by an arrow in FIG. 6 (counterclockwise direction). The charging device 42, the exposure device 44, the development device 46, the transfer device 48, and the cleaning blade 52 are provided in this order around the image carrier 30 from the upstream side of the rotation direction of the image carrier 30.

The charging device 42 charges the surface of the image carrier 30 (e.g., circumferential surface) to positive polarity. The charging device 42 is, for example, a charging roller.

The exposure device 44 applies exposure light to the charged surface of the image carrier 30. That is, the exposure device 44 exposes the charged surface of the image carrier 30. This forms an electrostatic latent image on the surface of the image carrier 30. The electrostatic latent image is formed on the basis of the image data input to the image forming apparatus 100.

The development device 46 supplies a toner to the surface of the image carrier 30 to develop the electrostatic latent image as a toner image. The development device 46 (e.g., the surface of the development device 46, more specifically, the circumferential surface of the development device 46) is in contact with the surface of the image carrier 30. That is, the image forming apparatus 100 adopts a contact development method. The development device 46 is, for example, a development roller. In the case where the developer is a one-component developer, the development device 46 supplies the toner that is a one-component developer to the electrostatic latent image formed on the image carrier 30. In the case where the developer is a two-component developer, the development device 46 supplies the toner, of the toner and the carrier included in the two-component developer, to the electrostatic latent image formed on the image carrier 30. In this way, the image carrier 30 carries the toner image.

The transfer belt 50 conveys the recording medium P between the image carrier 30 and the transfer device 48. The transfer belt 50 is an endless belt. The transfer belt 50 is provided to be rotatable in the direction indicated by an arrow in FIG. 6 (clockwise direction).

The transfer device 48 transfers the toner image developed by the development device 46 from the surface of the image carrier 30 to a to-be-transferred body. The to-be-transferred body is the recording medium P. When the toner image is transferred, the image carrier 30 is in contact with the recording medium P. That is, the image forming apparatus 100 adopts a direct transfer method. The transfer device 48 is, for example, a transfer roller.

The image carrier 30 is recharged by the charging device 42 while no static electricity is eliminated in a region where the toner image has been transferred to the recording medium P that is a to-be-transferred body. In general, transfer memory is likely to occur in the image forming apparatus that adopts a static electricity elimination-free system. However, the image forming apparatus 100 according to this embodiment is capable of suitably suppressing transfer memory by including, as the image carrier 30, the photoreceptor 1 capable of suppressing transfer memory, even when adopting a static electricity elimination-free system. For this reason, the image forming apparatus 100 according to this embodiment is particularly effective in the case where a static electricity elimination-free system including no static elimination device is adopted.

The recording medium P on which the toner image has been transferred by the transfer device 48 is conveyed to the fixing device 54 by the transfer belt 50. The fixing device 54 is, for example, a heating roller and/or a pressure roller. The unfixed toner image transferred by the transfer device 48 is heated and/or pressurized by the fixing device 54. When the toner image is heated and/or pressurized, the toner image is fixed to the recording medium P. As a result, an image is formed on the recording medium P.

An example of the image forming apparatus according to this embodiment has been described above. However, the image forming apparatus according to this embodiment is not limited to the image forming apparatus 100 described above. For example, the image forming apparatus 100 described above has been a color image forming apparatus. However, the image forming apparatus according to this embodiment may be a monochrome image forming apparatus. In this case, the image forming apparatus according to this embodiment only needs to include, for example, only one image formation unit. Further, the image forming apparatus 100 described above has adopted a tandem system. However, the image forming apparatus according to this embodiment may adopt, for example, a rotary method. Further, the image forming apparatus 100 described above has adopted a contact development method. However, the image forming apparatus according to this embodiment may adopt a non-contact development method. Further, the image forming apparatus 100 described above has adopted a direct transfer method. However, the image forming apparatus according to this embodiment may adopt an intermediate transfer method. In the case where the image forming apparatus according to this embodiment adopts an intermediate transfer method, the to-be-transferred body corresponds to the intermediate transfer belt. Further, the image formation unit 40 described above described above has included no static elimination device. However, the image formation unit included in the image forming apparatus according to this embodiment may further include a static elimination device. Further, the image formation unit 40 described above has included a cleaning blade. However, the image formation unit included in the image forming apparatus according to this embodiment does not necessarily need to include a cleaning member such as a cleaning blade. Further, in this embodiment, a charging roller has been described as an example of the charging device 42. However, the charging device included in the image forming apparatus according to this embodiment may be a charging device other than the charging roller (e.g., a scorotron charger, a charging brush, or a corotron charger).

### Third Embodiment: Process Cartridge

Next, an example of a process cartridge according to a third embodiment of the present disclosure will be described with reference to FIG. 6. The process cartridge according to this embodiment corresponds to each of the image formation units 40a to 40d. The process cartridge according to this embodiment includes the image carrier 30. The image carrier 30 corresponds to the photoreceptor 1 according to the first embodiment. As described above, the photoreceptor 1 according to the first embodiment has excellent abrasion resistance, filming resistance, and scratch resistance and is capable of suppressing transfer memory. Therefore, the process cartridge according to this embodiment includes, as the image carrier 30, the photoreceptor 1 according to the first embodiment, which allows the abrasion resistance, filming resistance, and scratch resistance of the image carrier 30 to be improved and the transfer memory to be suppressed.

The process cartridge according to this embodiment further includes at least one selected from the group consisting of the charging device 42, the exposure device 44, the development device 46, and the transfer device 48, in addition to the image carrier 30. The process cartridge according to this embodiment may further include one or both of the cleaning blade 52 and a static elimination device (not shown). The process cartridge according to this embodiment is designed to be attachable/detachable to/from the image forming apparatus 100. For this reason, the process cartridge according to this embodiment is easy to handle, and when the sensitivity characteristics of the image carrier 30 or the like deteriorate, it can be easily and quickly replaced including the image carrier 30.

The process cartridge including the photoreceptor 1 according to the first embodiment has been described above as an example of the process cartridge according to this embodiment with reference to FIG. 6. However, the process cartridge according to this embodiment is not limited to the process cartridge including the photoreceptor 1 according to the first embodiment. The process cartridge according to this embodiment can be modified in the same way as the modified example of the image formation unit described above (e.g., modified example described in the second embodiment).

### EXAMPLES

The present disclosure will be more specifically described below by way of Examples. However, the present disclosure is not limited to the following Examples. In the following, a stacked photoreceptor was formed as a photoreceptor.

[Synthesis of Polyarylate Resins (R-1) to (R-11) and (r-1) to (r-4)]

Polyarylate resins (R-1) to (R-7) and polyarylate resins (r-1) to (r-4) in which, in the formula (Y), W1, W2, W3, and W4 represent the repeating units shown in Table 2 were synthesized by the following method. Note that as described above, the polyarylate resins (R-1) to (R-7) are the specific polyarylate resins.

TABLE 2

| Polyarylate resin | W¹ | W² | W³ | W⁴ |
|---|---|---|---|---|
| r-1 | P-1 | C-4 | P-5 | C-4 |
| r-2 | P-2 | C-4 | P-2 | C-4 |
| r-3 | P-3 | C-3 | P-3 | C-3 |
| r-4 | P-2 | C-2 | P-2 | C-4 |

### [Synthesis of Polyarylate Resin (R-1)]

A three-neck flask including a thermometer, a three-way cock, and a dropping funnel was used as a reaction vessel. A compound (1-1) that is a monomer (41.0 mmol), 2,6-dimethylphenol as a terminal stopper (0.413 mmol), sodium hydroxide as a base (98 mmol), and benzyltributylammonium chloride as a catalyst (0.384 mmol) were placed in the reaction vessel, and the air in the reaction vessel was replaced with argon gas. Subsequently, water (300 mL) was added to the content of the reaction vessel, and the content of the reaction vessel was stirred at 50° C. for 1 hour. After that, the content of the reaction vessel was cooled to 10° C. to obtain an alkaline aqueous solution S-A.

Next, dicarboxylic acid dichloride of a compound (2-2) that is a monomer (16.0 mmol) and dicarboxylic acid dichloride of a compound (2-3) that is a monomer (16.0 mmol) were dissolved in chloroform (150 mL). In this way, a chloroform solution S-B was obtained.

Subsequently, the chloroform solution S-B was slowly added dropwise into the alkaline aqueous solution S-A using a dropping funnel over 110 minutes. Subsequently, while adjusting the temperature (liquid temperature) of the content of the reaction vessel to 15±5° C., the content of the reaction vessel was stirred for 4 hours to allow the polymerization reaction to proceed. After that, the upper layer (acquire layer) of the content of the reaction vessel was removed using a decant to obtain an organic layer (OL-1).

Meanwhile, ion exchanged water (400 mL) was added to an Erlenmeyer flask. Subsequently, the organic layer (OL-1) obtained by the above-mentioned polymerization reaction was further added to this Erlenmeyer flask. Subsequently, chloroform (400 mL) and acetic acid (2 mL) were further added to this Erlenmeyer flask. After that, the content of the Erlenmeyer flask was stirred at room temperature (25° C.) for 30 minutes. After that, the upper layer (aqueous layer) of the content of the Erlenmeyer flask was removed using a decant to obtain an organic layer (OL-2). The obtained organic layer (OL-2) was washed with ion exchanged water (1 L) using a separating funnel. The washing with ion exchanged water was repeated five times to obtain the organic layer (OL-2) that has been washed with a total of 5 L of ion exchanged water. Next, the washed organic layer (OL-2) was filtered to obtain the filtrate. Subsequently, this filtrate was slowly added dropwise into methanol (1 L) to obtain a precipitate. Subsequently, this precipitate was taken out by filtration. The taken precipitate was vacuum dried at a temperature of 70° C. for 12 hours. As a result, the polyarylate resin (R-1) having the composition (types and addition rates of monomers) shown in table 3 was obtained.

[Synthesis of Polyarylate Resins (R-2) to (R-7) and (r-1) to (r-4)]

The polyarylate resins (R-2) to (R-7) and (r-1) to (r-4) were synthesized in the same manner as that for the synthesis of the polyarylate resin (R-1) except that the types and addition rate of the monomers were changed as shown in Table 3. Note that the addition amount of each bisphenol monomer was set such that the total amount of bisphenol monomer would be 41.0 mmol and the addition rate of bisphenol would be as shown in Table 1. For example, in the synthesis of the polyarylate resin (R-2), the addition amount of the compound (1-1) was 38.95 mmol (=41.0×95/100) and the addition amount of the compound (1-4) was 2.05 mmol (=41.0×5/100). Further, the addition amount of each dicarboxylic acid monomer was set such that the total amount of dicarboxylic acid monomer would be 32.0 mmol and the addition rate of dicarboxylic acid would be as shown in Table 2. For example, in the synthesis of the resin (R-2), the addition amount of the compound (2-1) was 20.8 mmol (=32.0×65/100) and the addition amount of the compound (2-2) was 11.2 mmol (=32.0×35/100).

1H-NMR (proton nuclear magnetic resonance analysis) was used to identify the obtained polyarylate resins (R-1) to (R-7) and (r-1) to (r-4).

### [Measurement of Viscosity Average Molecular Weight]

Further, the viscosity average molecular weight of each of the obtained polyarylate resins (R-1) to (R-7) and (r-1) to (r-4) was measured in accordance with Japanese Industrial Standard (JIS) K7252-1:2016. The measured viscosity average molecular weights are shown in Table 3 together with the compositions of the polyarylate resins (R-1) to (R-7) and (r-1) to (r-4).

Note that in Table 3, the “monomer” indicates the monomer used to synthesize the polyarylate resin. The “forming unit” indicates the repeating unit formed from the corresponding monomer. The “resin” indicates the polyarylate resin. The “bisphenol addition rate” indicates the percentage (unit: %) of the amount (unit: mole) of the corresponding bisphenol monomer with respect to the total amount (unit: mole) of bisphenol monomer added in the synthesis of the polyarylate resin. The “dicarboxylic acid addition rate” indicates the percentage (unit: %) of the amount (unit: mole) of the corresponding dicarboxylic acid monomer with respect to the total amount (unit: mole) of dicarboxylic acid monomer added in the synthesis of the polyarylate resin. The “DMP” indicates 2,6-dimethylphenol.

TABLE 3

| | Monomer | | | | | | | | | | |
|---|---|---|---|---|---|---|---|---|---|---|---|
| | Bisphenol addition rate [%] | | | | | Dicarboxylic acid addition rate [%] | | | | | Viscosity |
| | 1-1 | 1-2 | 1-3 | 1-4 | 1-5 | 2-1 | 2-2 | 2-3 | 2-4 | | average |
| | Forming unit | | | | | | | | | Terminal | molecular |
| | P-1 | P-2 | 1-3 | P-4 | P-5 | C-1 | C-2 | C-3 | C-4 | stopper | weight |
| Resin(R-1) | 100 | — | — | — | — | — | 50 | 50 | — | DMP | 53000 |
| Resin(R-2) | 95 | — | — | 5 | — | 65 | 35 | — | — | DMP | 61200 |
| Resin(R-3) | 80 | — | — | 20 | — | — | 50 | 50 | — | DMP | 59000 |
| Resin(R-4) | 60 | — | — | 40 | — | 100 | — | — | — | DMP | 62000 |
| Resin(R-5) | 80 | — | — | — | 20 | 50 | 50 | — | — | DMP | 58100 |
| Resin(R-6) | 80 | — | — | — | 20 | 80 | — | — | 20 | DMP | 54900 |
| Resin(R-7) | 80 | — | — | — | 20 | — | — | 65 | 35 | DMP | 58200 |
| Resin(r-1) | 80 | — | — | — | 20 | — | — | — | 100 | DMP | 57600 |
| Resin(r-2) | — | 100 | — | — | — | — | — | — | 100 | DMP | 67900 |
| Resin(r-3) | — | — | 100 | — | — | — | — | 100 | — | DMP | 49000 |
| Resin(r-4) | — | 100 | — | — | — | — | 65 | — | 35 | DMP | 62300 |

### [Production of Photoreceptors (A-1) to (A-8) and (B-1) to (B-13)]

Photoreceptors (A-1) to (A-8) according to Examples 1 to 8 and photoreceptors (B-1) to (B-13) according to Comparative Example 1 to 13 were produced by the following method.

[Production of Photoreceptor (a-1)]

### Preparation of Coating Liquid for Intermediate Layer:

Methanol, n-butanol, and toluene were mixed to obtain a solvent V-A (mass ratio: methanol/n-butanol/toluene=3/1/1). 1.00 part by mass of a polyamide resin (“Amilan (registered trademark) CM8000” manufactured by TORAY INDUSTRIES, INC., a quaternary copolymerized polyamide resin of polyamide 6, polyamide 12, polyamide 66, and polyamide 610) was dissolved in 4.00 parts by mass of the solvent V-A to obtain a resin solution V-B. 2.00 parts by mass of titanium oxide, 0.50 parts by mass of ion exchanged water, 5.00 parts by mass of the resin solution V-B, and 8.00 parts by mass of the solvent V-A were mixed under the condition of a circumferential speed of 8 m/see for 6 hours using a circulation wet disperser (“DYNO (registered trademark)-MILL” manufactured by Willy A Bachofen AG) to obtain a coating liquid for an intermediate layer. Note that as the titanium oxide, a prototype “SMT-A” (number average particle size of 10 nm) manufactured by TAYCA Co., Ltd., which was subjected to primary surface treatment using alumina and silica and then secondary surface treatment using methylhydrogenpolysiloxane, was used.

### Formation of Intermediate Layer:

The obtained coating liquid for an intermediate layer was filtered using a filter with an opening of 30.00 μm. After that, the coating liquid for an intermediate layer was applied to the surface of a conductive substrate by a dip coating method. As the conductive substrate, a drum-shaped support (diameter: 30.00 mm, length: 245.00 mm) formed of aluminum was used. Subsequently, the applied coating liquid for an intermediate layer was heat-treated at 120° C. for 20 minutes to form an intermediate layer (film thickness: 0.70 μm) on the conductive substrate.

### Preparation of Coating Liquid for Charge Generating Layer:

Propylene glycol monomethylether and tetrahydrofuran were mixed to obtain a solvent V-C (mass ratio: propylene glycol monomethylether/tetrahydrofuran=1/2). 1.00 part by mass of a polyvinylacetal resin (“S-LEC BX-5” manufactured by SEKISUI CHEMICAL CO., LTD.) was dissolved in 19.00 parts by mass of the solvent V-C to obtain a resin solution V-D. 2.30 parts by mass of a Y-type titanyl phthalocyanine as a charge generating agent, 20.00 parts by mass of the resin solution V-D (amount of the polyvinylacetal resin: 1.00 part by mass), and 65.00 parts by mass of the solvent V-C were mixed using a media disperser (bead mill) to obtain a coating liquid for a charge generating layer. The mixing conditions were as follows.
Circumferential speed: 60 rpm
Mixing time: 4 hours
Media of media disperser: zirconia beads (diameter of 0.65 mm)
Filling rate of media of media disperser: 46.2%

### Formation of Charge Generating Layer:

The obtained coating liquid for a charge generating layer was filtered using a filter with an opening of 5 μm. The obtained filtrate was applied onto the intermediate layer by a dip coating method and heat-treated at 90° C. for 20 minutes. In this way, a charge generating layer (film thickness: 0.5 μm) was formed on the intermediate layer.

### Preparation of Coating Liquid for Charge Transporting Layer:

Toluene and tetrahydrofuran were mixed to obtain a solvent V-E (mass ratio: toluene/tetrahydrofuran=1/9). 61.00 parts by mass of the compound (HTM1) as a hole transporting agent, 2.00 parts by mass of the compound (EA1) as an electron acceptor compound, 0.05 parts by mass of dimethylsilicone oil (“KF96-50CS” manufactured by Shin-Etsu Chemical Co., Ltd.) as a leveling agent, 100.00 parts by mass of the polyarylate resin (R-1), and 4.00 parts by mass of the compound (AOX1) as an antioxidant were dissolved in 650.00 parts by mass of the solvent V-E to obtain a coating liquid for a charge transporting layer. Note that as described above, the compound (AOX1) is the specific antioxidant.

### Formation of Charge Transporting Layer:

The obtained coating liquid for a charge transporting layer was applied onto the charge generating layer by a dip coating method, heated at the heating rate of 1° C./min from 60° C. to 125° C., and then heat-treated at 125° C. for a total of 60 minutes. In this way, a charge transporting layer (film thickness: 26.00 μm) was formed on the charge generating layer to obtain a photoreceptor (A-1). The photoreceptor (A-1) included the intermediate layer on the conductive substrate, the charge generating layer on the intermediate layer, and the charge transporting layer on the charge generating layer.

[Production of Photoreceptors (a-2) to (a-8) and (B-1) t (B-13)]

Each of photoreceptors (A-2) to (A-8) and (B-1) to (B-13) was produced in the same way as the method of producing the photoreceptor (A-1) except that at least one of the type of polyarylate resin, the type of antioxidant, or the content of the antioxidant in the coating liquid for a charge transporting layer was changed as shown in Table 4.

### [Evaluation]

The filming resistance, scratch resistance, suppression of transfer memory (transfer memory potential difference), and abrasion resistance of each of the obtained photoreceptors (A-1) to (A-8) and (B-1) to (B-13) were evaluated by the following method.

### Evaluation of Filming Resistance and Scratch Resistance:

For the evaluation, a sheet of paper (“Askul Multipaper Super Economy+” sold by ASKUL Corporation) was used. Further, as an evaluation device for the evaluation, a modified machine of an image forming apparatus (“FS-C5250DN” manufactured by KYOCERA Document Solutions Inc.) was used. This evaluation device included, as a charging device, a charging roller formed of an epichlorohydrin resin in which conductive carbon was dispersed. The charge polarity of the charging roller was positive polarity, and the applied voltage of the charging roller was a direct current voltage. Further, this evaluation device adopted a two-component development method and an intermediate transfer method. Further, this evaluation device included a cleaning blade and a static elimination device.

The photoreceptor was mounted on the evaluation device, and an image I (character image with a coverage rate of 5%) was continuously printed on 50,000 sheets of paper in an environment of a temperature of 23° C. and a relative humidity of 50% RH using this evaluation device. Subsequently, an image II (image including a halftone image and a white background image) was printed on one sheet of paper using the evaluation device, and the obtained image was used as a first evaluation image.

After obtaining the first evaluation image, the photoreceptor was taken out from the evaluation device. The surface of the photoreceptor was observed with the naked eye to check scratches and the presence or absence of the occurrence of filming on the surface of the photoreceptor. After the observation with the naked eye, the photoreceptor was mounted on the evaluation device again.

Subsequently, the image I (character image with a coverage rate of 5%) was continuously printed on 50,000 sheets of paper in an environment of a temperature of 10° C. and a relative humidity of 15% RH using the evaluation device. Subsequently, the image II (image including a halftone image and a white background image) was printed on one sheet of paper using the evaluation device, and the obtained image was used as a second evaluation image.

The first evaluation image and the second evaluation image were observed to check the presence or absence of image defects derived from scratches and filming. Image defects derived from scratches include, for example, white streaks and black streaks. Image defects derived from filming include, for example, dash marks and fogging. The dash marks are black dots arranged parallel to the conveying direction of the sheet of paper. The larger the area on the surface of the photoreceptor where filming has occurred, the more likely it is that fogging starting from the dash marks occurs in the formed image. The filming resistance and scratch resistance were evaluated on the basis of the following criteria from the result of checking the surface of the photoreceptor and the results of checking the image defects of the first evaluation image and the second evaluation image.

A (Particularly good): Neither scratches nor filming occurred on the surface of the photoreceptor. Further, no image defects occurred in both the first evaluation image and the second evaluation image.

B (Good): At least one of scratches or filming occurred on the surface of the photoreceptor. However, no image defects occurred in both the first evaluation image and the second evaluation image.

C (Poor): At least one of scratches or filming occurred on the surface of the photoreceptor. Further, image defects occurred in at least one of the first evaluation image or the second evaluation image.

### Evaluation of Suppression of Transfer Memory (Evaluation of Transfer Memory Potential Difference):

The suppression of transfer memory (referred to also as “transfer memory resistance”) was evaluated in an environment of a temperature of 23° C. and a relative humidity of 65% RH. The photoreceptor was charged using a drum sensitivity tester (manufactured by GENTEC, without a static elimination device) at the rotational speed of the photoreceptor of 220 rpm such that the surface potential of the photoreceptor would be −600 V. Subsequently, the monochromatic light (a wavelength: 780 nm, an exposure amount: 0.08 μJ/cm2) extracted from light of a halogen lamp using a bandpass filter was applied to the surface of the photoreceptor while causing a current of +15 μA to flow through the transfer device. The surface potential of the photoreceptor after the application of monochromatic light had ended and then the photoreceptor had rotated once was measured. The measured surface potential was used as a potential at 15 μA (VL1, unit: −V).

Subsequently, the photoreceptor was charged and the monochromatic light was applied in the same manner as that for the measurement of the potential at 15 μA(VL1) except that the current flowing through the transfer device was changed from +15 μA to +5 μA. The surface potential of the photoreceptor after the application of monochromatic light had ended and then the photoreceptor had rotated twice was measured. The measured surface potential was used as a potential at 5 μA (VL2, unit: −V).

The transfer memory potential difference (unit: V) was calculated from the formula “Transfer memory potential difference=(potential VL2 at 5 μA)−(potential VL1 at 15 μA)”. The suppression of transfer memory (transfer memory potential difference) was evaluated on the basis of the following criteria.

A (Good): the transfer memory potential difference is −10.0 V or more.

B (Poor): the transfer memory potential difference is less than −10.0 V.

### Evaluation of Abrasion Resistance:

The coating liquid for a charge transporting layer prepared in each of Examples or Comparative Examples was applied to a polypropylene sheet (thickness: 0.3 mm) wrapped around a pipe (diameter: 78 mm) formed of aluminum. The applied coating liquid for a charge transporting layer was dried in an oven for 70 minutes to prepare a polypropylene sheet in which a charge transporting layer (film thickness of 30.00 μm) was formed. The heating conditions in the oven were the starting temperature of 60° C., the final temperature of 130° C., and the heating rate of 1° C./min. Subsequently, the charge transporting layer was peeled off from the polypropylene sheet. Subsequently, the peeled charge transporting layer was attached to a card-shaped member (“S-36” manufactured by Taber industries). A mass MA of the card-shaped member attached to the charge transporting layer was then measured. Subsequently, the card-shaped member to which the charge transporting layer had been attached was mounted on the rotating table of a rotary abrasion tester (manufactured by Toyo Seiki Seisaku-sho, Ltd.). Subsequently, the rotating table was caused to rotate 1,000 times at the rotational speed of 60 rpm while an abrasion wheel (“CS-10” manufactured by Taber industries) with a weight of 500 gf was placed on the charge transporting layer attached to the card-shaped member. In this way, the charge transporting layer on the rotating table was abrased. After the abrasion, a mass MB of the card-shaped member to which the charge transporting layer had been attached was measured. The abrasion loss (=MA−MB, unit: mg), i.e., the mass change of the charge transporting layer before and after the abrasion, was calculated. The abrasion resistance of the photoreceptor was evaluated from the abrasion loss on the basis of the following criteria.

### Evaluation Criteria for Abrasion Resistance:

A (Good): the abrasion loss is 10.0 mg or less.

B (Poor): the abrasion loss exceeds 10.0 mg.

The evaluation results of filming resistance and scratch resistance, the evaluation results of a transfer memory potential difference and suppression of transfer memory, and the evaluation results of abrasion loss and abrasion resistance are collectively shown in Table 4.

Note that in Table 4, the “resin” indicates a polyarylate resin. The “type” of an antioxidant indicates the type of compound used as an antioxidant in the corresponding Example or Comparative Example. “AOX2” indicates the compound represented by the formula (AOX2), and “AOX3” indicates the compound represented by the formula (AOX3). Note that hereinafter, the compounds represented by the formulae (AOX2) and (AOX3) will be respectively referred to as the compounds (AOX2) and (AOX3) in some cases.

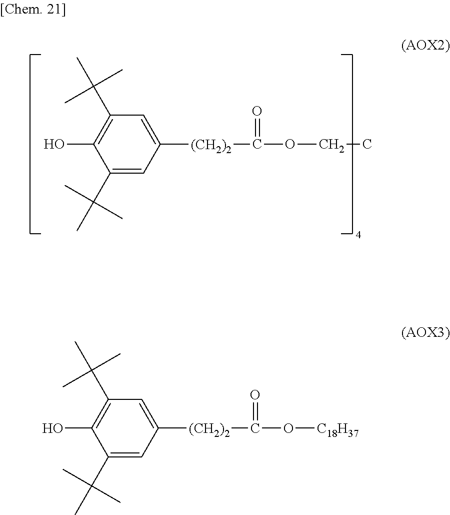

Further, in Table 4, the “amount” of the antioxidant indicates the number of parts by mass of the antioxidant with respect to 100.00 parts by mass of the polyarylate resin used. The “part” indicates the parts by mass. The content (number of parts by mass) of the antioxidant in each coating liquid for a charge transporting layer with respect to 100.00 parts by mass of the polyarylate resin in each coating liquid for a charge transporting layer is maintained even after the charge transporting layer is formed. The “filming/scratches” indicates the evaluation results of filming resistance and scratch resistance. The “photosensitive layer formation not possible” indicates that the polyarylate resin was not dissolved in the solvent for forming a coating liquid for a charge transporting layer and the coating liquid for a charge transporting layer could not be prepared, so that the photosensitive layer could not be formed and the corresponding evaluation and measurement could not be carried out. “-” indicates that the corresponding component is not used.

TABLE 4

| | | | | | Suppression of transfer memory | | | Abrasion resistance | |
|---|---|---|---|---|---|---|---|---|---|
| | | | Antioxidant | | Potential | | | Abrasion | |
| | | | | Amount | difference | | Filming/ | loss | |
| | Photoreceptor | Resin | Type | [part] | [V] | Evaluation | scratches | [mg] | Evaluation |
| Example 1 | A-1 | R-1 | AOX1 | 4.00 | −8.9 | A | A | 8.6 | A |
| Example 2 | A-2 | R-2 | AOX1 | 4.00 | −8.1 | A | A | 6.1 | A |
| Example 3 | A-3 | R-3 | AOX1 | 4.00 | −8.0 | A | A | 5.9 | A |
| Example 4 | A-4 | R-3 | AOX1 | 8.00 | −6.8 | A | A | 6.2 | A |
| Example 5 | A-5 | R-4 | AOX1 | 2.00 | −8.8 | A | A | 7.0 | A |
| Example 6 | A-6 | R-5 | AOX1 | 4.00 | −8.2 | A | A | 7.3 | A |
| Example 7 | A-7 | R-6 | AOX1 | 4.00 | −7.0 | A | A | 7.2 | A |
| Example 8 | A-8 | R-7 | AOX1 | 4.00 | −8.0 | A | A | 7.9 | A |
| Comparative | B-1 | R-2 | AOX2 | 4.00 | −8.8 | A | A | 11.0 | B |
| Example 1 | | | | | | | | | |
| Comparative | B-2 | R-7 | AOX2 | 4.00 | −7.8 | A | A | 10.9 | B |
| Example 2 | | | | | | | | | |
| Comparative | B-3 | R-3 | AOX3 | 4.00 | −8.4 | A | A | 10.3 | B |
| Example 3 | | | | | | | | | |
| Comparative | B-4 | R-2 | — | — | −11.0 | B | A | 6.5 | A |
| Example 4 | | | | | | | | | |
| Comparative | B-5 | R-7 | — | — | −11.2 | B | A | 6.6 | A |
| Example 5 | | | | | | | | | |
| Comparative | B-6 | r-1 | AOX1 | 4.00 | −8.8 | A | C | 13.0 | B |
| Example 6 | | | | | | | | | |
| Comparative | B-7 | r-2 | — | — | −12.0 | B | C | 16.2 | B |
| Example 7 | | | | | | | | | |
| Comparative | B-8 | r-2 | AOX1 | 4.00 | −11.9 | B | C | 16.3 | B |
| Example 8 | | | | | | | | | |
| Comparative | B-9 | r-2 | AOX2 | 4.00 | −11.9 | B | C | 20.3 | B |
| Example 9 | | | | | | | | | |
| Comparative | B-10 | r-3 | — | — | −11.7 | B | B | 11.5 | B |
| Example 10 | | | | | | | | | |
| Comparative | B-11 | r-3 | AOX1 | 4.00 | −12.2 | B | B | 11.0 | B |
| Example 11 | | | | | | | | | |
| Comparative | B-12 | r-3 | AOX3 | 4.00 | −11.9 | B | C | 14.1 | B |
| Example 12 | | | | | | | | | |
| Comparative | B-13 | r-4 | — | — | Photosensitive layer formation not possible | | | | |
| Example 13 | | | | | | | | | |

As shown in Table 4, each of the photoreceptors (B-1) to (B-3) according to Comparative Examples 1 to 3 included, in the photosensitive layer, the specific polyarylate resin (R-2), (R-7), or (R-3) having the repeating units (1) and (2). Further, each of the photoreceptors (B-1) to (B-3) included, in the photosensitive layer, a hole transporting agent and an antioxidant. However, each of the photoreceptors (B-1) to (B-3) used the compound (AOX2) or (AOX3) as an antioxidant, and did not include, in the photosensitive layer, the compound (AOX1) that was the specific antioxidant. The abrasion loss of each of the photoreceptors (B-1) to (B-3) exceeded 10.0 mg and the evaluation result of abrasion resistance was “B” (Poor).

As shown in Table 4, each of the photoreceptors (B-4) and (B-5) according to Comparative Examples 4 and 5 included, in the photosensitive layer, the specific polyarylate resin (R-2) or (R-7) having the repeating units (1) and (2), and a hole transporting agent. However, each of the photoreceptors (B-4) and (B-5) did not include, in the photosensitive layer, an antioxidant. The transfer memory potential difference of each of the photoreceptors (B-4) and (B-5) was less than −10.0 V and the evaluation result of suppression of transfer memory was “B” (Poor).

As shown in Table 4, the photoreceptor (B-6) according to Comparative Example 6 included, in the photosensitive layer, the compound (AOX1) that was the specific antioxidant. Further, the photoreceptor (B-6) included, in the photosensitive layer, a hole transporting agent and a polyarylate resin. However, the photoreceptor (B-6) used, as a polyarylate resin, the polyarylate resin (R-1) that did not have the repeating unit (2), and did not include, in the photosensitive layer, the specific polyarylate resin. In the photoreceptor (B-6), at least filming occurred on the surface of the photoreceptor and image defects occurred in the second evaluation image. For this reason, the evaluation result of filming resistance and scratch resistance was “B” (Poor). Further, the abrasion loss of the photoreceptor (B-6) exceeded 10.0 mg and the evaluation result of abrasion resistance was “B” (Poor).

As shown in Table 4, the photoreceptor (B-7) according to Comparative Example 7 did not include, in the photosensitive layer, an antioxidant. Further, the photoreceptor (B-7) used, as a polyarylate resin, the polyarylate resin (R-2) that did not include the repeating units (1) and (2), and did not include, in the photosensitive layer, the specific polyarylate resin. In the photoreceptor (B-7), at least filming occurred on the surface of the photoreceptor and image defects occurred in the second evaluation image. For this reason, the evaluation result of filming resistance and scratch resistance was “B” (Poor). Further, the abrasion loss of the photoreceptor (B-7) exceeded 10.0 mg and the evaluation result of abrasion resistance was “B” (Poor).

As shown in Table 4, the photoreceptor (B-8) according to Comparative Example 8 included, in the photosensitive layer, the compound (AOX1) that was the specific antioxidant. Further, the photoreceptor (B-8) included, in the photosensitive layer, a hole transporting agent and a polyarylate resin. However, the photoreceptor (B-8) used, as a polyarylate resin, the polyarylate resin (R-2) that did not include the repeating units (1) and (2), and did not include, in the photosensitive layer, the specific polyarylate resin. In the photoreceptor (B-8), at least filming occurred on the surface of the photoreceptor and image defects occurred in the second evaluation image. For this reason, the evaluation result of filming resistance and scratch resistance was “B” (Poor). Further, the transfer memory potential difference of the photoreceptor (B-8) was less than −10.0 V and the evaluation result of suppression of transfer memory was “B” (Poor). Further, the abrasion loss of the photoreceptor (B-8) exceeded 10.0 mg and the evaluation result of abrasion resistance was “B” (Poor).

As shown in Table 4, the photoreceptor (B-9) according to Comparative Example 9 used, as an antioxidant, the compound (AOX2), and did not include the compound (AOX1) that was the specific antioxidant. Further, the photoreceptor (B-9) used, as a polyarylate resin, the polyarylate resin (R-2) that did not include the repeating units (1) and (2), and did not include, in the photosensitive layer, the specific polyarylate resin. In the photoreceptor (B-9), at least filming occurred on the surface of the photoreceptor and image defects occurred in the second evaluation image. For this reason, the evaluation result of filming resistance and scratch resistance was “B” (Poor). Further, the transfer memory potential difference of the photoreceptor (B-9) was less than −10.0 V and the evaluation result of suppression of transfer memory was “B” (Poor). Further, the abrasion loss of the photoreceptor (B-9) exceeded 10.0 mg and the evaluation result of abrasion resistance was “B” (Poor). The abrasion loss of the photoreceptor (B-9) was larger than that of the photoreceptor (B-8) that included, in the photosensitive layer, the compound (AOX1) that was the specific antioxidant.

As shown in Table 4, the photoreceptor (B-10) according to Comparative Example 10 did not include, in the photosensitive layer, an antioxidant. Further, the photoreceptor (B-10) used, as a polyarylate resin, the polyarylate resin (R-3) that did not have the repeating unit (1), and did not include, in the photosensitive layer, the specific polyarylate resin. For this reason, the transfer memory potential difference of the photoreceptor (B-10) was less than −10.0 V and the evaluation result of suppression of transfer memory was “B” (Poor). Further, the abrasion loss of the photoreceptor (B-10) exceeded 10.0 mg and the evaluation result of abrasion resistance was “B” (Poor).

As shown in Table 4, the photoreceptor (B-11) according to Comparative Example 11 included, in the photosensitive layer, the compound (AOX1) that was the specific antioxidant. However, the photoreceptor (B-8) used, as a polyarylate resin, the polyarylate resin (R-3) that did not have the repeating unit (1), and did not include, in the photosensitive layer, the specific polyarylate resin. The transfer memory potential difference of the photoreceptor (B-11) was less than −10.0 V and the evaluation result of suppression of transfer memory was “B” (Poor). Further, the abrasion loss of the photoreceptor (B-11) exceeded 10.0 mg and the evaluation result of abrasion resistance was “B” (Poor).

As shown in Table 4, the photoreceptor (B-12) according to Comparative Example 12 used, as an antioxidant, the compound (AOX3), and did not include the compound (AOX1) that was the specific antioxidant. Further, the photoreceptor (B-12) used, as a polyarylate resin, the polyarylate resin (R-3) that did not have the repeating unit (1), and did not include, in the photosensitive layer, the specific polyarylate resin. In the photoreceptor (B-12), at least filming occurred on the surface of the photoreceptor and image defects occurred in the second evaluation image. For this reason, the evaluation result of filming resistance and scratch resistance was “B” (Poor). Further, the transfer memory potential difference of the photoreceptor (B-12) was less than −10.0 V and the evaluation result of suppression of transfer memory was “B” (Poor). Further, the abrasion loss of the photoreceptor (B-12) exceeded 10.0 mg and the evaluation result of abrasion resistance was “B” (Poor). The abrasion loss of the photoreceptor (B-12) was larger than that of the photoreceptor (B-8) that included, in the photosensitive layer, the compound (AOX1) that was the specific antioxidant.

As shown in Table 4, in the production of the photoreceptor (B-13) according to Comparative Example 13, no antioxidant was used and the polyarylate resin (R-4) that did not include the repeating unit (1) was used as a polyarylate resin. The polyarylate resin (R-4) was not dissolved in the solvent for forming a coating liquid for a charge transporting layer as described above, and the photosensitive layer could not be formed.

Meanwhile, as shown in Table 4, the photosensitive layer of each of the photoreceptors (A-1) to (A-8) produced in Examples 1 to 8 included any of the polyarylate resins (R-1) to (R-7) that was specific polyarylate having the repeating units (1) and (2), a hole transporting agent, and the compound (AOX1) that was the specific antioxidant. In the photoreceptors (A-1) to (A-8), both scratches and filming did not occur and the evaluation result of filming resistance and scratch resistance was “A” (Particularly good). Further, in the photoreceptors (A-1) to (A-8), the transfer memory potential difference was −10.0 or more, the abrasion loss was 10.0 mg or less, and the evaluation results of suppression of transfer memory and abrasion resistance were “A” (Good).

In particular, when comparing Example 2 with Comparative Example 4 or Example 8 with Comparative Example 5, it can be seen that the transfer memory can be sufficiently suppressed (in other words, transfer memory resistance is improved) by including the specific antioxidant in the photosensitive layer. Meanwhile, when comparing Comparative Example 7 with Comparative Example 8 or Comparative Example 10 with Comparative Example 11, there is no improvement in the transfer memory resistance due to the inclusion of the specific antioxidant in the photosensitive layer, and it can be seen that the effect of the specific antioxidant occurs only when the photosensitive layer uses the specific polyarylate resin.

Further, for example, when comparing Example 1 with Example 3, it can be seen that when the specific polyarylate resin further has, for example, the repeating unit (P-4) as the repeating unit derived from bisphenol, in addition to the repeating unit (1), it is possible to obtain the photoreceptor 1 having more excellent abrasion resistance and effect of suppressing transfer memory.

Further, for example, when comparing Example 6 with Example 7, it can be seen that when the specific polyarylate resin further has the repeating unit represented by the formula (C-4) as the repeating unit derived from dicarboxylic acid, in addition to the repeating unit (2), it is possible to obtain the photoreceptor 1 having more excellent abrasion resistance and effect of suppressing transfer memory.

As described above, the photoreceptor according to the present disclosure, which includes the photoreceptors (A-1) to (A-8), has surface properties that allow the abrasion on the photoreceptor surface to be reduced and the occurrence of filming to be suppressed, and is capable of suppressing the occurrence of transfer memory. Therefore, in accordance with the present disclosure, it is possible to provide a photoreceptor that has excellent abrasion resistance, filming resistance, and scratch resistance and is capable of suppressing transfer memory. Further, it is possible to provide a process cartridge and an image forming apparatus that have excellent abrasion resistance, filming resistance, and scratch resistance of the photoreceptor and are capable of suppressing transfer memory by including the photoreceptor according to the present disclosure.

It should be understood by those skilled in the art that various modifications, combinations, sub-combinations and alterations may occur depending on design requirements and other factors insofar as they are within the scope of the appended claims or the equivalents thereof.

What is claimed is:

1. An electrophotographic photoreceptor, comprising:
a conductive substrate; and
a photosensitive layer,
the photosensitive layer including a polyarylate resin, a hole transporting agent, and an antioxidant,
the polyarylate resin including a repeating unit represented by the following formula (1) and a repeating unit represented by the following formula (2),
the antioxidant being a compound represented by the following formula (AOX1): 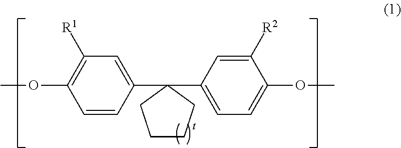
wherein, in the formula (1), R¹ and R² each independently represent a hydrogen atom or a methyl group and t represents an integer of 1 or more and 3 or less; 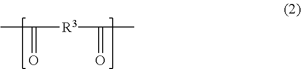
wherein, in the formula (2), R₃ represents a divalent group represented by the following formula (X1), (X2), or (X3); 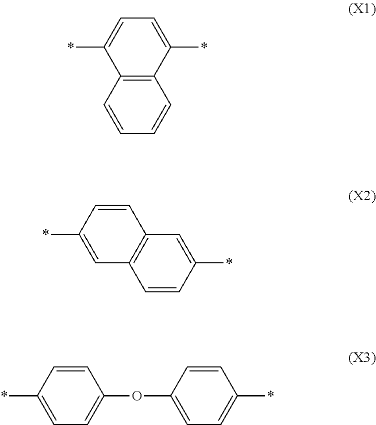
wherein, in the formulae (X1), (X2), and (X3), * represents atomic bonding;

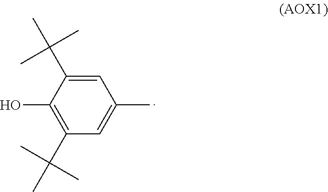 [SMILES: Cc1cc(C(C)(C)C)c(O)c(C(C)(C)C)c1 ; "."]

2. The electrophotographic photoreceptor according to claim 1, wherein
the repeating unit represented by the formula (1) is a repeating unit represented by the following formula (P-1):

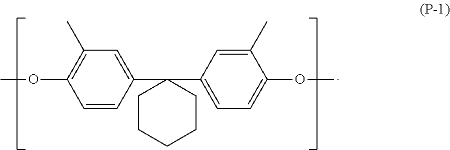

3. The electrophotographic photoreceptor according to claim 1, wherein
the polyarylate resin further includes at least one of repeating units represented by the following formulae (P-2), (P-3), (P-4), (P-5), and (C-4):

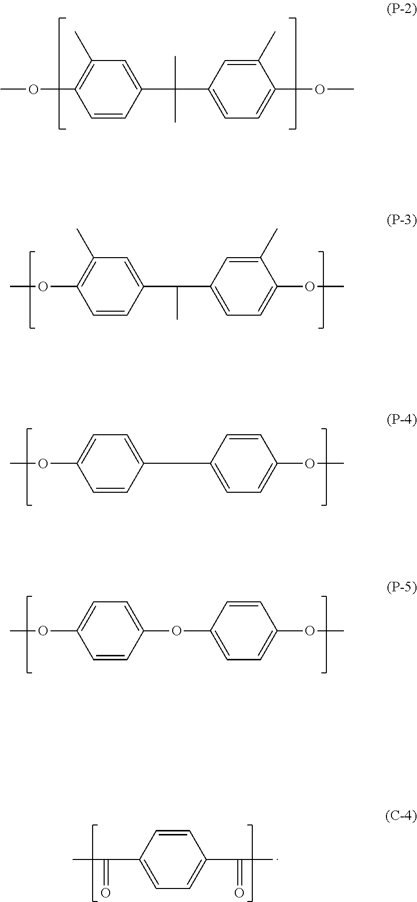

4. The electrophotographic photoreceptor according to claim 1, wherein
the hole transporting agent has a triphenylamine structure.

5. The electrophotographic photoreceptor according to claim 1, wherein
a content of the antioxidant in the photosensitive layer is 1.00 part by mass or more and 10.00 parts by mass or less with respect to 100.00 parts by mass of the polyarylate resin.

6. The electrophotographic photoreceptor according to claim 1, wherein
the photosensitive layer includes a charge generating layer including a charge generating agent and a charge transporting layer including the polyarylate resin, the hole transporting agent, and the antioxidant.

7. A process cartridge, comprising:
at least one selected from the group consisting of a charging device, an exposure device, a development device, and a transfer device; and
the electrophotographic photoreceptor according to claim 1.

8. An image forming apparatus, comprising:
an image carrier;
a charging device that charges a surface of the image carrier;
an exposure device that exposes the charged surface of the image carrier to form an electrostatic latent image on the surface of the image carrier;
a development device that supplies a toner to the surface of the image carrier to develop the electrostatic latent image as a toner image; and
a transfer device that transfers the toner image from the image carrier to a to-be-transferred body,
the image carrier being the electrophotographic photoreceptor according to claim 1.

9. The image forming apparatus according to claim 8, wherein
the image carrier is recharged by the charging device while no static electricity is eliminated in a region where the toner image has been transferred to the to-be-transferred body.
